(19) United States
(12) Patent Application Publication
(10) Pub. No.: US 2006/0047704 A1
(43) Pub. Date: Mar. 2, 2006

(54) Method and system for providing information services relevant to visual imagery

(76) Inventor: Kumar Chitra Gopalakrishnan, Mountain View, CA (US)

Correspondence Address: Kokka Intellectual Property Group, PC, Suite 4, 800 San Antonio Road, Palo Alto, CA, 94303, US

(21) Appl. No.: 11/215,601

(22) Filed: Aug. 30, 2005

Related U.S. Application Data
(60) Provisional application No. 60/606,282, filed on Aug. 31, 2004.

(51) Int. Cl. G06F 17/00

(52) U.S. Cl. 707/104.1

(57) ABSTRACT

A method and system for providing information services relevant to visual imagery is described, including performing an operation on a context constituent. Also described is generating a context to provide an information service relevant to visual imagery, including generating a context constituent, and forming the context by performing an operation, the context including the context constituent. Providing an information service is also described, including presenting the information service on a client user interface, displaying an attribute of the information service, and acquiring a user input and a sensor input.

### CROSS REFERENCE TO RELATED APPLICATIONS

This application claims priority to U.S. Provisional Patent Application No. 60/606,282 (Attorney Docket No. 9467) entitled “METHOD AND APPARATUS FOR PROVIDING INFORMATION SERVICES RELEVANT TO VISUAL IMAGERY,” filed Aug. 31, 2004, which is incorporated by reference for all purposes.

### FIELD OF THE INVENTION

The present invention relates generally to multimedia computer information systems and multimedia communication. More specifically, a method and system for providing information services relevant to visual imagery is described.

### BACKGROUND OF THE INVENTION

A bar code based system is an example of a system that uses visual input for object identification and information access. In bar code based systems, a bar code (i.e., a one or two-dimensional graphical representation of an alphanumeric code) is read with a scanning device and used to identify an object on which the bar code is attached. Once the object is identified, information related to the code is retrieved from a computer information system. Bar-code based systems are used for industrial applications such as UPC code based transaction processing, document tracking, and package tracking.

Bar code, and other such visual identifier based systems rely on the availability of a comprehensive database containing the unique identifiers that are identified by the system. The unique identifiers are used to identify objects associated with the identifiers. Hence, comprehensive databases of unique identifiers enable conventional systems to identify objects associated with the identifiers. However, such systems have several shortcomings. First, it is impractical to create and assign unique identifiers for every object that needs to be identified and associate appropriate information with those identifiers. Second, manufacturing and attaching such unique identifiers to every object is also impractical and inefficient. Third, if a unique identifier extracted from an object is not available in the database of unique identifiers, such unique identifier based systems are unable to provide information associated with the object. Thus, such object identification systems in general and unique identifier based systems in particular, work only for limited collections of objects and fail completely when presented with objects or unique identifiers unknown to the system.

Thus, there is a need for a solution for providing information services relevant to visual imagery.

### BRIEF DESCRIPTION OF THE DRAWINGS

Various embodiments of the invention are disclosed in the following detailed description and the accompanying drawings:

FIG. 1 illustrates an exemplary system, in accordance with an embodiment;

FIG. 2 illustrates an alternative view of an exemplary system, in accordance with an embodiment;

FIG. 3A illustrates a front view of an exemplary client device, in accordance with an embodiment;

FIG. 3B illustrates a rear view of an exemplary client device, in accordance with an embodiment;

FIG. 4 illustrates another alternative view of an exemplary system, in accordance with an embodiment;

FIG. 5(a) illustrates an exemplary login view of a user interface, in accordance with an embodiment;

FIG. 5(b) illustrates an exemplary settings view of a user interface, in accordance with an embodiment;

FIG. 5(c) illustrates an exemplary author view of a user interface, in accordance with an embodiment;

FIG. 5(d) illustrates an exemplary home view of a user interface, in accordance with an embodiment;

FIG. 5(e) illustrates an exemplary search view of a user interface, in accordance with an embodiment;

FIG. 5(f) illustrates an exemplary folders view of a user interface, in accordance with an embodiment;

FIG. 5(g) illustrates an exemplary content view of a user interface, in accordance with an embodiment;

FIG. 5(h) illustrates an exemplary content view of a user interface, in accordance with an embodiment;

FIG. 6 illustrates an exemplary message structure, in accordance with an embodiment;

FIG. 7(a) illustrates an exemplary user access privileges table, in accordance with an embodiment;

FIG. 7(b) illustrates an exemplary user group access privileges table, in accordance with an embodiment;

FIG. 7(c) illustrates an exemplary information service classifications table, in accordance with an embodiment;

FIG. 7(d) illustrates an alternative exemplary user groups table, in accordance with an embodiment;

FIG. 7(e) illustrates an exemplary information services ratings table listing individual users' ratings, in accordance with an embodiment;

FIG. 7(f) illustrates an exemplary information services ratings table listing user groups' ratings, in accordance with an embodiment;

FIG. 7(g) illustrates an exemplary aggregated information services ratings table for users and user groups, in accordance with an embodiment;

FIG. 7(h) illustrates an exemplary author ratings table, in accordance with an embodiment;

FIG. 7(i) illustrates an exemplary client device characteristics table, in accordance with an embodiment;

FIG. 7(j) illustrates an exemplary user profiles table, in accordance with an embodiment;

FIG. 7(k) illustrates an exemplary environmental characteristics table, in accordance with an embodiment;

FIG. 7(l) illustrates an exemplary logo information table, in accordance with an embodiment;

FIG. 8(a) illustrates an exemplary process for starting a client, in accordance with an embodiment;

FIG. 8(b) illustrates an exemplary process for authenticating a client on a system server, in accordance with an embodiment;

FIG. 9 illustrates an exemplary process for capturing visual information and starting client-system server interaction, in accordance with an embodiment;

FIG. 10(a) illustrates an exemplary process of system server operation for generating contexts, in accordance with an embodiment;

FIG. 10(b) illustrates an exemplary process for processing natural content, in accordance with an embodiment;

FIG. 10(c) illustrates an exemplary process for extracting embedded information from enhanced natural content, in accordance with an embodiment;

FIG. 10(d) illustrates an exemplary process for querying information from a knowledge base, in accordance with an embodiment;

FIG. 10(e) illustrates an exemplary process for generating natural content from information in machine interpretable format, in accordance with an embodiment;

FIG. 10(f) illustrates an exemplary process for requesting information services from a system server, in accordance with an embodiment;

FIG. 11 illustrates an exemplary process for generating contexts from context constituents, in accordance with an embodiment;

FIG. 12 illustrates an exemplary process for accessing and interacting with information services on a client, in accordance with an embodiment;

FIG. 13 illustrates an exemplary process for requesting contexts and information services when client 402 is running in autonomous mode and presenting relevant information services without user action, in accordance with an embodiment;

FIG. 14 illustrates an exemplary process for hyperlinking information services to other information services, in accordance with an embodiment; and

FIG. 15 is a block diagram illustrating an exemplary computer system suitable for providing information services relevant to visual imagery, in accordance with an embodiment.

### DETAILED DESCRIPTION

Various embodiments may be implemented in numerous ways, including as a system, a process, an apparatus, or a series of program instructions on a computer readable medium such as a computer readable storage medium or a computer network where the program instructions are sent over optical, electrical, electronic, or electromagnetic communication links. In general, the steps of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The described techniques identify and provide information services that relate to visual imagery without having to identify physical objects in the visual imagery. Providing information services relevant to visual imagery is described, including a description of exemplary information services, a method for the generation of information services, a system for providing information services, and the operation of the system. Visual imagery used for providing information services may be in the form of still pictures or video sequences or a combination thereof. Visual imagery may be captured from a physical environment or a visual display (e.g., a computer monitor or a television display). Visual imagery may also be sourced from pre-recorded sources such as still images or video sequences that were captured and stored.

Information services relevant to visual imagery provided by the system may include information and optionally features and instructions for the handling of information. As used herein, the term “information associated with an information service” may refer to the information included in an information service. Information services may enable the delivery, creation, deletion, modification, classification, storing, sharing, communication and inter-association of information. Further, information services may also enable the delivery, creation, deletion, modification, classification, storing, sharing, communication and inter-association of other information services. Furthermore, information services may also enable the control of other physical and information systems in physical or computer environments. As used herein, the term “physical systems” may refer to objects, systems, and mechanisms that may have a material or tangible physical form. Examples of physical systems include a television, a robot or a garage door opener. As used herein, the term “information systems” may refer to processes, systems, and mechanisms that process information. Examples of information systems include a software algorithm or a knowledge base. Furthermore, information services may enable the execution of financial transactions. Information services may contain one or more data/media types such as text, audio, still images and video. Further, information services may include instructions for one or more processes, such as delivery of information, management of information, sharing of information, communication of information, acquisition of user and sensor inputs, processing of user and sensor inputs and control of other physical and information systems. Furthermore, information services may include instructions for one or more processes, such as delivery of information services, management of information services, sharing of information services and communication of information services. Information services may be provided from sources internal to the system or external to the system. Sources external to the system may include the Internet. Examples of Internet services include World Wide Web, email and the like. An exemplary information service may comprise of a World Wide Web page that includes both information and instructions for presenting the information. Examples of more complex information services include Web search, e-commerce, comparison shopping, streaming video, computer games and the like. In another example, an information service may provide a modified version of the information or content from a World Wide Web resource or URL.

In some embodiments, delivery of information services may include providing the spatial and temporal formatting and layout information for the information services. Similarly, in some other embodiments, delivery of information associated with information services may include providing the spatial and temporal formatting and layout information for the information associated with information services. In some embodiments, information services may include controls for generating various commands and activating functionality provided by the system. In some embodiments, information services may be provided in conjunction with visual imagery in the form of overlays or embedded information services for an “augmented reality” experience. In other embodiments, information services may be presented independent of the visual imagery. In some embodiments, information services are provided upon request. In other embodiments, information services are provided upon the occurrence of pre-defined events or upon the meeting of pre-defined criteria. In some embodiments, information services include features that enable the creation, deletion, modification, classification, storage and sharing of information and other information services. In some embodiments, access to information, information services and their classifications may be restricted to select users using the authentication, authorization and accounting (AAA—described below), user groups and Digital Rights Management (DRM) features included in information services. In some embodiments, the classifications of information services and information associated with information services may be managed using a folder hierarchy. In some embodiments, information and information services may be communicated to recipients (e.g., other users of system 100 and other third party entities external to system 100) through communication mechanisms (e.g., SMS, email, instant messaging, voice calls, video calls, and the like). A voice call initiated with visual imagery as input is an example of an information service incorporating features for communicating information. In some embodiments, inter-associations may be established between information services through hyperlinks embedded in information services. In other embodiments, inter-associations may be established between information associated with information services using hyperlinks embedded in information services. Information services may be used by users or other physical and information systems. For example, an information service may switch a television to a specific channel. In some embodiments, instructions included in information services may activate various user interface controls and functionality integrated into the client. In other embodiments, instructions included in information services may add new controls and functionality to the client or modify existing controls and functionality on the client. In some other embodiments, information services may also be synthesized from a plurality of other information services.

Information services are associated with visual imagery through interpretation of context constituents associated with the visual imagery. Context constituents associated with visual imagery may include: 1) embedded visual elements derived from the visual imagery, 2) metadata and user inputs associated with the visual imagery and 3) relevant knowledge derived from knowledge bases.

Embedded visual elements derived from visual imagery include textual elements, formatting attributes of textual elements, graphical elements, information on the layout of the textual and graphical elements in the visual imagery, and characteristics of different regions of the visual imagery. Visual elements may either be in machine generated form (e.g., printed text) or manually generated form (e.g., handwritten text). Visual elements may be distributed across multiple still images or video frames of the visual imagery. Examples of textual elements derived from visual imagery include alphabets, numerals, symbols, and pictograms. Examples of formatting attributes of textual elements derived from visual imagery include fonts used to represent the textual elements, size of the textual elements, color of the textual elements, style of the textual elements (e.g., use of bullets, engraving, embossing) and emphasis (e.g., bold or regular typeset, italics, underlining). Examples of graphical elements derived from visual imagery include logos, icons and graphical primitives (e.g., lines, circles, rectangles and other shapes). Examples of layout information of textual and graphical elements derived from visual imagery include absolute position of the textual and graphical elements, position of the textual and graphical elements relative to each other, and position of the textual and graphical elements relative to the spatial and temporal boundaries of the visual imagery. Examples of characteristics of regions derived from visual imagery include size, position, spatial orientation, motion shape, color and texture of the regions.

Metadata associated with the visual imagery include, but are not limited to, the spatial and temporal dimensions of the visual imagery, location of the user, location of the client device, spatial orientation of the user, spatial orientation of the client device, motion of the user, motion of the client device, explicitly specified and learned characteristics of client device (e.g., network address, telephone number and the like), explicitly specified and learned characteristics of the client (e.g., version number of the client and the like), explicitly specified and learned characteristics of the communication network (e.g., measured rate of data transfer, latency and the like), audio information associated with video visual imagery, ambient audio information from the environment of capture of visual imagery and explicitly specified and learned preferences of the user.

User inputs included in the contexts constituents may include inputs in audio, visual, textual or tactile format. In some embodiments, user inputs may include commands for performing various operations and commands for activating various features integrated into the system.

Knowledge bases contributing to the context constituents include, but are not limited to, a database of user profiles, a database of client device features and capabilities, a database of users' history of usage, a database of user access privileges for the information and information services in the system, a membership database for various user groups in the system, a database of explicitly specified and learned popularity of information and information services available in the system, a database of explicitly specified and learned popularity of authors contributing information and information services to the system, a knowledge base of classifications of information and information services in the system, a knowledge base of explicitly specified and learned characteristics of the client devices used, a knowledge base of explicitly specified and learned user preferences, a knowledge base of explicitly specified and learned environmental characteristics, and other knowledge bases containing specialized knowledge on various domains such as a database of logos, an electronic thesaurus, a database of the grammar, syntax and semantics of languages, knowledge bases of domain specific ontologies or a Geographic Information System. In some embodiments, the system may include a knowledge base of the syntax and semantics of common textual (e.g., telephone number, email address, Internet URL) and graphical entities (e.g., common symbols like “X” for “no”, etc.) that have well defined structures.

Information services are associated with visual imagery through generation of contexts, which are comprised of context constituents. Contexts with varying degrees of relevance to the visual imagery are generated from context constituents through various permutations and combinations of the context constituents. Information services identified as relevant to the contexts associated with a visual imagery form the available set of information services identified as relevant to the visual imagery.

The association of information services to contexts may be done manually or automatically by the system. In some embodiments, the system generates contexts from context constituents associated with visual imagery and provides relevant information services through an automated process as described below. The generation of a plurality of contexts, each of which may have a varying degree of relevance to the visual imagery, and the association of information services of varying degree of relevance to the contexts, provide aggregated sets of information services ranked by their relevance to the visual imagery. In some embodiments, the sets of information services sorted by relevance provide users with a plurality of information service choices that exhibit a structured degradation of the relevance of the information services to the visual imagery. Further, if information services relevant to complex contexts constituted from a multitude of context constituents are not available, information services relevant to simpler contexts composed from subsets of the available context constituents may be substituted. Thus, the system may provide information services of reduced relevance for contexts for which the system does not have associated information services by listing information services relevant to contexts formed from subsets of the context constituents. Sometimes, information services identified as relevant to visual imagery by the system may not be relevant to the self-evident meaning represented by the contexts or physical objects present in the visual imagery. Similarly, sometimes, the contexts generated from an available set of context constituents may not be relevant to the self-evident meaning represented by the visual imagery or the physical objects present in the visual imagery.

Information services provided may be categorized as commercial, sponsored or regular information services based on the presence of any financial transactions associated with the information services. Commercial information services may be information services paid for by the users of the information services. Commercial information services may be provided by users, operators of the system, or other third party entities external to the system. The use of such services is monitored and accounted by the AAA features and the associated cost is billed to users of the commercial information services. Sponsored information services may be paid for by the providers of the sponsored information services. Sponsored information services may be provided by users, operators of the system, or other third party entities external to the system. Further, sponsored information services may be provided in solicited and unsolicited formats. The use of such services is monitored and accounted by the AAA features and the associated cost is billed to the providers of the sponsored information services. Information services that are not commercial or sponsored information services are termed as regular information services. Commercial and regular information services together may be referred to as non-sponsored information services. Sponsored and regular information services together may be referred to as non-commercial information services. Furthermore, information services that are an aggregate of commercial, sponsored and non-sponsored information services may also supported by some embodiments. In such aggregate information services, the sponsored and non-sponsored information services may be interspersed, presented alongside, or separated using a spatial or temporal layout. In some embodiments, sponsored and non-sponsored information services may be displayed using different media formats or devices (e.g., a mobile phone (audio) and a mobile projective display (video)).

The AAA features integrated into the system may enable the creation of a market for licenses to associate commercial and sponsored information services with contexts. Such a market enables providers of commercial and sponsored information services to buy licenses to associate commercial and sponsored information services with specific contexts from the operators of the system.

The features of information services provided by the system enable the creation of information services targeted for various applications including, but not limited to, information retrieval, information authoring, marketing, financial transactions, authentication, communication, entertainment content and games.

One type of information service enabled by the system retrieves and presents information from a plurality of sources. An exemplary information retrieval service enhances printed matter by providing additional relevant information. The term “printed matter” refers to textual and graphical matter printed on books, newspapers, presentations, signboards, etc. Printed matter may also include engraved and embossed textual and graphical elements. In this type of information services, visual elements extracted from visual imagery of printed matter provide contexts for identifying information services that provide relevant information. Examples of information provided by information retrieval services include information from the World Wide Web (e.g. product prices, news, weather, stock quotes and the like), information from dictionaries, information from thesauruses, reader comments and additional multimedia content relevant to the printed matter. The use of this type of information services, transforms the reading or browsing of textual and graphical information in printed matter into an interactive multimedia experience with “hypothetical hyperlinks” to relevant information “embedded” in the printed matter that are accessible using the system. Further, the information presented may be personalized for each user based on the user's preferences, environment and activity.

One type of information service enabled by the system enables users to associate new information with visual imagery. In an exemplary information authoring service, visual elements extracted from visual imagery of objects such as a restaurant menu card, a milk carton or a signboard may provide contexts for creating or authoring new information. The new information authored by users may include information in audio, visual or textual formats and may be stored in association with information services relevant to the generated contexts. When a user subsequently uses an information retrieval service with visual imagery containing similar contexts, i.e., visual imagery containing similar visual elements as that of the restaurant menu card, milk carton or signboard, the new information authored as described earlier using the information authoring service is presented to the user. Further, the system may also enable restriction of access to the newly authored information to select users and anonymous authoring of information. Furthermore, hyperlinks to other information and information services may also be embedded in the newly authored information.

One type of information service enabled by the system provides marketing messages (e.g., advertisements, infomercials and coupons), relevant to visual imagery. In an exemplary marketing information service, visual elements extracted from visual imagery provide contexts for identifying relevant marketing information services. In some embodiments, such marketing information services may be in the form of sponsored information services. In other embodiments, the marketing information services may also include commercial and regular information features. Marketing information services may provide marketing messages upon explicit request by the user or automatically as unsolicited communication.

One type of information service enabled by the system provides shopping or financial transaction functionality relevant to visual imagery. In an exemplary financial transaction service, visual elements extracted from visual imagery provide contexts for identifying relevant financial transaction information services. The financial transaction functionality provided by information services may include presentation of financial transaction information (e.g., price, availability, inventory and shipping charges) and e-commerce features. Further, financial transaction information services may include the capability to execute financial transactions based on the financial transaction information presented using hyperlinks to commercial transactions embedded in the information service. In an exemplary financial transaction service, the financial textual information on credit cards (e.g., the credit card holder name, credit card number, expiration date and issuing bank name) may be extracted from visual imagery of a credit card and used to complete a financial transaction (i.e., charge a transaction to the credit card account). The amount charged to the credit card may be entered explicitly by a user, obtained by an authentication information service from visual imagery, or obtained from information embedded in the authentication information service.

Another type of information service enabled by the system enables communication of information. In an exemplary communication information service, visual elements extracted from visual imagery provide contexts for identifying relevant communication services (e.g., voice calls, video calls, SMS, instant messaging, email, and the like). For example, a person's name extracted from visual imagery may be used to setup a voice call. In another example, information relevant to visual imagery retrieved using an information retrieval service may be communicated as email using a communication information service.

One type of information service enabled by the system provides entertainment content relevant to visual imagery. In some embodiments, visual elements extracted from visual imagery provide contexts for identifying entertainment information services that provide entertainment content relevant to the visual imagery. For example, video sequences of movie trailers may be presented by the entertainment information service when the contexts extracted from the visual imagery are identified as movie titles.

One type of information service enabled by the system enables the creation of games relevant to visual imagery. In an exemplary game information service, visual elements extracted from visual imagery provide contexts for creating a stand-alone gaming experience or enhance the functionality of other games. For example, in an embodiment of a game information service, users follow a clue trail of textual or graphical information extracted from visual imagery of various objects to score points. The game information service may also keep track of scores of all players of the game information service to enable users to compete against each other. In other embodiments, the game information service may provide customization features for other games. As an example, a car racing game may use the game information service to input the name of the player from visual imagery. Game information services may also add a context adaptive perspective to the pre-defined content used in video games. For example, a car racing game may use the game information service to overlay the latest scoreboard from a real car race onto the user interface of the car racing game and also position the cars similar to the position of the cars in the real car race.

Another type of information service enabled by the system enables authoring and management of new information services relevant to visual imagery. In an exemplary information service authoring service, visual elements extracted from visual imagery provide contexts for authoring a new information service where the new information service is composed of information and a method of presentation of the information. In an exemplary information service management service, information services may be hyperlinked together or the features of the information service e.g. information, method of presentation, access control, etc. modified.

As used herein, the term “knowledge base” is used to define specialized information stores since, as opposed to databases, knowledge bases not only store data but may also include additional elements that define the structure of the data and may include specific logic and metadata that are unique to the domains of knowledge that they contain. In some embodiments, a knowledge base may be substituted with a database in a system, if the information on the structure of data in the database or the logic used to interpret the data in the database is integrated into another component of the system. Similarly, a knowledge base with trivial structures for the data and trivial logic to interpret the knowledge base may be converted to a database. The knowledge bases and databases used to constitute the contexts can be internal to the system or external to the system, as in the case of the World Wide Web.

As used herein, the term “natural media format” may refer to content in formats suitable for reproduction on output components or suitable for capture through input components. The term “operators” refers to a person on business entity that operates a system as described below.

System Architecture

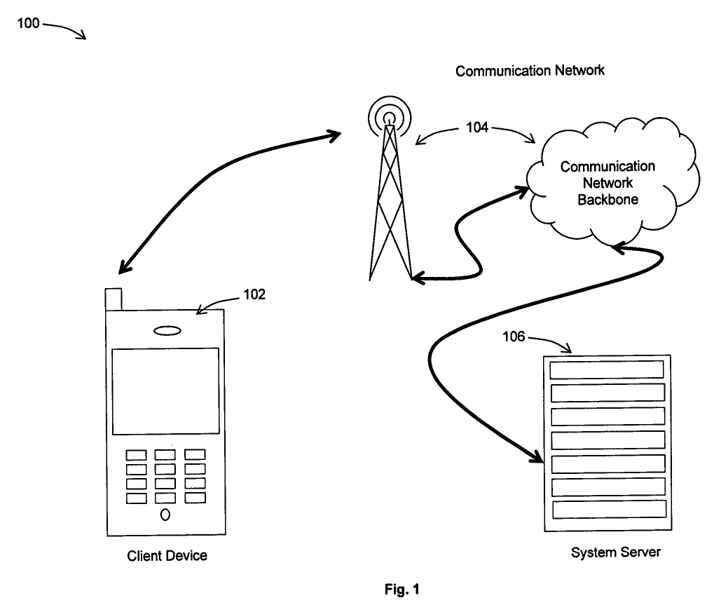

FIG. 1 illustrates an exemplary system, in accordance with an embodiment. Here, system 100 includes client device 102, communication network 104, and system server 106.

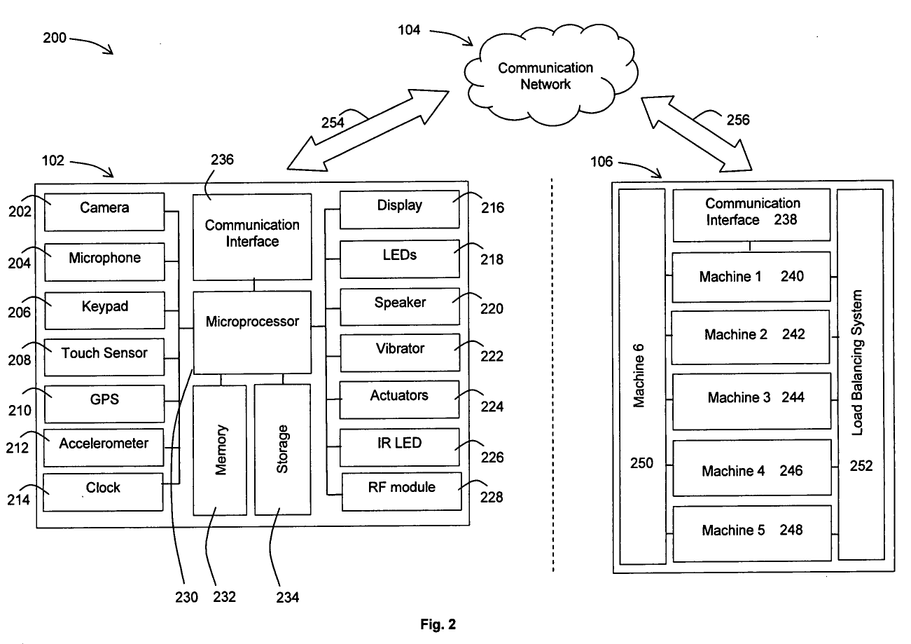

FIG. 2 illustrates an alternative view of an exemplary system, in accordance with an embodiment. System 200 illustrates the hardware components of the exemplary embodiment (e.g., client device 102, communication network 104, and system server 106). Here, client device 102 communicates with system server 106 over communication network 104. In some embodiments, client device 102 may include camera 202, microphone 204, keypad 206, touch sensor 208, global positioning system (GPS) module 210, accelerometer 212, clock 214, display 216, visual indicators (e.g., LEDs) and/or a projective display (e.g., laser projection display systems) 218, speaker 220, vibrator 222, actuators 224, IR LED 226, Radio Frequency (RF) module (i.e., for RF sensing and transmission) 228, microprocessor 230, memory 232, storage 234, and communication interface 236. System server 106 may include communication interface 238, machines 240-250, and load balancing subsystem 252. Data flows 254-256 are transferred between client device 102 and system server 106 through communication network 104.

Client device 102 includes camera 202, which is comprised of a visual sensor and appropriate optical components. The visual sensor may be implemented using a Charge Coupled Device (CCD), a Complementary Metal Oxide Semiconductor (CMOS) image sensor or other devices that provide similar functionality. The camera 202 is also equipped with appropriate optical components to enable the capture of visual imagery. Optical components such as lenses may be used to implement features such as zoom, variable focus, auto focus, and aberration-compensation. Client device 102 may also include a visual output component (e.g., LCD panel display) 216, visual indicators (e.g., LEDs) and/or a projective display (e.g., laser projection display systems) 218, audio output components (e.g., speaker 220), audio input components (e.g., microphone 204), tactile input components (e.g., keypad 206, keyboard (not shown), touch sensor 208, and others), tactile output components (e.g., vibrator 222, mechanical actuators 224, and others) and environmental control components (e.g., Infrared LED 226, Radio-Frequency (RF) transceiver 228, vibrator 222, actuators 224). Client device 102 may also include location measurement components (e.g., GPS receiver 210), spatial orientation and motion measurement components (e.g., accelerometers 212, gyroscope), and time measurement components (e.g., clock 214).

Examples of client device 102 may include communication equipment (e.g., cellular telephones), business productivity gadgets (e.g., Personal Digital Assistants (PDA)), consumer electronics devices (e.g., digital camera and portable game devices or television remote control). In some embodiments, components, features and functionality of client device 102 may be integrated into a single physical object or device such as a camera phone.

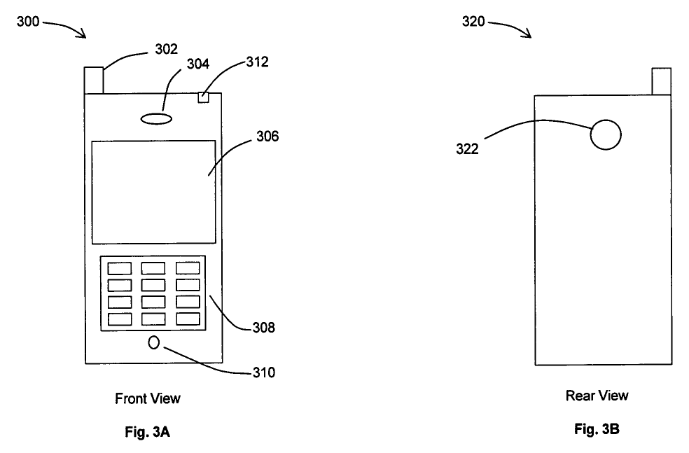

FIG. 3A illustrates a front view of an exemplary client device, in accordance with an embodiment. In some embodiments, client device 300 may be implemented as client device 102. Here, the front view of client device 300 includes communication antenna 302, speaker 304, display 306, keypad 308, microphone 310, and a visual indicator such as a Light Emitting Diode (LED) and/or a projective display 312. In some embodiments, display 306 may be implemented using a liquid crystal display (LCD), plasma display, cathode ray tube (CRT) or Organic LEDs.

FIG. 3B illustrates a rear view of an exemplary client device, in accordance with an embodiment. Here, rear view 320 illustrates the integration of camera 322 into client device 102. In some embodiments, a camera sensor and optics may be implemented such that a user may operate camera 322 using controls on the front of client device 102.

In some embodiments, client device 102 is a single physical device (e.g., a wireless camera phone). In other embodiments, client device 102 may be implemented in a distributed configuration across multiple physical devices. In such embodiments, the components of client device 102 described above may be integrated with other physical devices that are not part of client device 102. Examples of physical devices into which components of client device 102 may be integrated include cellular phone, digital camera, Point-of-Sale (POS) terminal, webcam, PC keyboard, television set, computer monitor, and the like. Components (i.e., physical, logical, and virtual components and processes) of client device 102 distributed across multiple physical devices are configured to use wired or wireless communication connections among them to work in a unified manner. In some embodiments, client device 102 may be implemented with a personal mobile gateway for connection to a wireless Wide Area Network (WAN), a digital camera for capturing visual imagery and a cellular phone for control and display of information services with these components communicating with each other over a wireless Personal Area Network such as Bluetooth™ or a LAN technology such as Wi-Fi (i.e., IEEE 802.11x). In some other embodiments, components of client device 102 are integrated into a television remote control or cellular phone while a television is used as the visual output device. In still other embodiments, a collection of wearable computing components, sensors and output devices (e.g., display equipped eye glasses, virtual retina displays, sensor equipped gloves, and the like) communicating with each other and to a long distance radio communication transceiver over a wireless communication network constitutes client device 102. In other embodiments, projective display 218 projects the visual information to be presented on to the environment and surrounding objects using light sources (e.g., lasers), instead of displaying it on display panel 216 integrated into the client device.

FIG. 4 illustrates another alternative view of an exemplary system, in accordance with an embodiment. Here, system 400 includes client device 102, communication network 104, and system server 106. In some embodiments, client device 102 may include microphone 204, keypad 206, touch sensor 208, GPS module 210, accelerometer 212, clock 214, display 216, visual indicator and/or projective display 218, speaker 220, vibrator 222, actuators 224, IR LED 226, RF module 228, memory 232, storage 234, communication interface 236, and client 402. In this exemplary embodiment, system server 106 may include communication interface 238, load balancing sub-system 252, front end-server 404, signal processing engine 406, recognition engine 408, synthesis engine 410, database 412, external information services interface 414, and application engine 416.

In some embodiments, client 402 may be implemented as a state machine that accepts visual, aural, and tactile input information along with the location, spatial orientation, motion and time from client device components. Using these inputs, client 402 analyzes, determines a course of action and performs one or more of the following: communicate with system server 106, present output information through visual, aural, and tactile output components or control the environment of client device 102 using control components (e.g., IR LED 226, RF module 228, visual indicator/projective display 218, vibrator 222 and actuators 224). Client 402 interacts with the user and the physical environment of client device 102 using the input, output and sensory components integrated into client device 102. Information exchanged and actions performed through these input, output, and sensory components by the user and client device environment contribute to the user interface of the client 402. Other functionality provided by a client user interface include the presentation of information services retrieved from system server 106, editing, and authoring of information services, inter-association of information services, sharing of information services, request of information services from specific classifications, classification of information services, communication of information services, management of user groups, presentation of various menu options for executing commands, and the presentation of a help system for explaining system features to the users. In some embodiments, client 402 may use the environmental control components integrated into client device 102 to control other physical systems in the physical environment of the client device 102 through Infrared, RF or mechanical signals. In some embodiments, a client user interface may include a viewfinder for live rendering of visual imagery captured by a visual sensor integrated into client device (e.g., camera 202) or visual imagery retrieved from storage 234. In some embodiments, an augmented view of visual imagery may be presented on the viewfinder by modifying an attribute (e.g., hue, saturation, contrast or brightness of a region, color, font, formatting, emphasis, style and others) of the visual imagery. The choice of attributes of visual imagery that are modified may be based on user preferences or automatically determined by system 100. In other embodiments, text, icons, or graphical content is embedded in the visual imagery to present an augmented view of the visual imagery. For example, when a collection of text words are viewed through the viewfinder, certain words may be underlined although they are not underlined in the visual scene of the actual physical environment. Such underlined text may indicate that they may be activated to retrieve information services relevant to them. Thus, the augmentation enables the creation of “hypothetical hyperlinks” on a physical environment i.e., a clickable user experience is superposed on a physical environment. The superimposed user experience, which may be accessed using the system, may not require changes to the physical environment. Thus, the system offers a mechanism for non-intrusive non-destructive association of information services to a physical environment.

In some embodiments, client 402 may be implemented as a software application for a software platform (e.g., Java 2 Micro Edition (J2ME) or Series60 or Symbian OS™) on client device 102. In this case, client device 102 may use a programmable microprocessor 230 with associated memory 232 and storage 234 to save and execute software and its associated data. In other embodiments, client 402 may also be implemented in hardware or firmware for a customized or reconfigurable electronic machine. In some embodiments, client 402 may reside on client device 102 or may be downloaded on to client device 102 from system server 106. In the latter example, client 402 may be upgraded or modified remotely. In some embodiments, client 402 may also interact with and modify other elements (i.e., applications or stored data) of client device 102.

In some embodiments, client 402 presents information services. In other embodiments, client 402 may present information services through other logic (e.g., software applications) integrated into client device 102. For example, information services may be presented through a web browser integrated into client device 102. In some other embodiments, the functionality of client 402 may be integrated in its entirety into other logic present in client device 102 such as a Web browser. In some embodiments where client device 102 is implemented as a distributed device whose components are distributed over a plurality of physical devices, components of client 402 may also be distributed over the plurality of physical devices comprising client device 102.

In some embodiments, a user may be presented visual information through display 216. Visual information for presentation may be encoded using appropriate source coding algorithms (e.g., Joint Picture Experts Group (JPEG), Graphics Interchange Format (GIF), Motion Picture Experts Group (MPEG), H.26x, Scalable Vector Graphics, Flash™ and the like). The encoded visual information is decoded before presentation on display 216. In other embodiments, visual information may also be presented through visual indicators and/or projective display 218. Display 216 may provide a graphical user interface while visual indicator 218 may provide visual indications of other forms of information (e.g., providing a flashing light indicator when new information services are available on the client for presentation to the user). The graphical user interface may be generated by client 402 using graphical widget primitives provided by software environments, such as those described above, in conjunction with custom graphics and bitmaps to provide a particular look and feel.

In some embodiments, audio information may be presented using speaker 220 and tactile information may be presented using vibrator 222. In some embodiments, audio information may be encoded using a source coding algorithm such as RT-CELP or AMR for cellular communication. Encoded audio information is decoded prior to being presented through speaker 220. Microphone 204, camera 202, and keypad 206 handle audio, visual and tactile inputs, respectively. Audio captured by microphone 204 may be encoded using a source coding algorithm by microprocessor 230.

In some embodiments, camera optics (not shown) may be implemented to focus an image on the camera sensor. Further, the camera optics may provide zoom and/or macro functionality. Focusing, zooming and macro operations are achieved by moving the optical surfaces of camera optics either manually or automatically. Manual focus, zooming and macro operations may be performed based on the visual imagery displayed on the client user interface using appropriate controls provided on the client user interface or client device 102. Automatic focus, zooming, and macro operations may be performed by logic that measures features (e.g., edges) of captured visual imagery and controls the optical surfaces of the camera optics appropriately to optimize the measured value of such features. The logic for performing such optical operations may be embedded in client 402 or embedded into the optical system.

Keypad 206 may be implemented as a number-oriented keypad or a full alpha-numeric ‘qwerty’ keypad. In some embodiments employing a camera phone, keypad 206 may be a numbers-only keypad, which provides a compact physical structure for the camera phone. The signal generated by the closing of the switches integrated into the keypad keys is translated into an ASCII, Unicode or other such textual representations by the software environment. Thus, the operations of the keypad keys are translated into a textual data stream for the client 402 by the software environment. The clock 214 integrated into client device provides the time and may be synchronized with the local or Universal time manually or automatically by the communication network 104. The location of client device 102 may be derived from an embedded GPS receiver 210 that uses the time difference between signals from the GPS satellites to triangulate the location of the Client Device. In other embodiments, the location of client device 102 may be determined using network assisted technologies such as Assisted Global Positioning System (AGPS) and Time Difference of Arrival (TDOA).

In some embodiments, client 402 may be implemented as software residing on a single-piece integrated device such as a camera phone. FIGS. 3A and 3B illustrate the external features of a wireless camera phone. Such a camera phone is a portable, programmable computer equipped with input, output, sensory, communication, and environmental control components such as those discussed above. The programmable computer may be implemented using a microprocessor 230 that executes software logic stored in local storage 234 using the memory 232 for temporary storage. Microprocessor 230 may be implemented using various technologies such as ARM or xScale. The storage may be implemented using media such as Flash memory or a Hard disk while memory may be implemented using DRAM or SRAM. Further, a software environment built into client device 102 enables the installation, execution, and presentation of software applications. Software environments may include an operating system to manage system resources (e.g., memory 232, storage 234, microprocessor 230, and the like), a middleware stack that provides libraries of commonly used functions and data, and a user interface through which a user may launch and interact with software applications. Examples of such software environments include Nokia™ Series60™, Palm™, Microsoft™Windows Mobile™, and Java J2ME™ These environments use SymbianOS™, PalmOS™, Windows CE™ and other Operating Systems in conjunction with other middleware and user interface software. As an example, client 402 may be implemented using J2ME as the software environment.

In some embodiments, system server 106 may be implemented in a datacenter equipped with appropriate power supply, cooling and communication support systems. In addition, more than one instance of system server 106 may be implemented in a datacenter or the multiple instances of system server 106 distributed across multiple datacenters to ensure reliability and fault tolerance. In other embodiments, distribution of functionality between client 402 and system server 106 may vary. Some components or functionality of client 402 may be realized on system server 106 and some components or functionality of system server 106 may be realized on client 402. For example, recognition engine 408 and synthesis engine 410 may be integrated into client 402. In another example, recognition engine 408 may be implemented partly on client 402 and partly on system server 106. As another example, a database may be used by client 402 to cache information for communication with system server 106. In some embodiments, system 100 may reside entirely on client device 102. In still other embodiments, a user's personal data storage equipment (e.g., home computer) may be used to store information services or host system server 106. In other embodiments, system server 106 may be implemented as a distributed peer-to-peer system residing on users' personal computing equipment (e.g., PCs, laptops, PDAs, and the like) or wearable computing equipment. The distribution of functions between client 402 and system server 106 may also be varied over the course of operation (i.e., over time). Components of system server 106 may be implemented as software, custom hardware logic, firmware on reconfigurable hardware logic or a combination thereof. In some embodiments, client 402 and system server 106 may be implemented on programmable infrastructure that enables the download or updating of new features, personalization based on a criteria including user preferences, adaptation for device capabilities, and custom branding. Components of system server 106 are described in greater detail below. In some embodiments, system server 106 may include more than one of each of the components described below.

In some embodiments, system server 106 may include a load balancing subsystem 252, which monitors the computational load on the components and distributes various tasks among the components in order to improve server component utilization and responsiveness. The load balancing system 252 may be implemented using custom software logic, Web switches or clustering software.

In some embodiments, front-end server 404 acts as an interface between communication network 104 and system server 106. Front-end server 404 ensures the integrity of the data in the messages received from client device 102 and forwards the messages to application engine 416. Unauthorized accesses to system server 106 or corrupted messages are dropped. Response messages generated by application engine 416 may also be routed through front-end server 404 to client 402. In other embodiments, front-end server 404 may be implemented differently other than as described above.

In some embodiments, signal processing engine 406 performs enhancement and modification of multimedia data in natural media formats such as audio, still images and video. The enhanced and modified multimedia data is used by recognition engine 408. Since the signal processing operations performed may be unique to each media type, signal processing engine 406 may include one or more independent software modules each of which may be used to enhance or modify a specific media type. Examples of processing functions performed by signal processing engine 406 modules are described below. Signal processing engine 406 and its various embodiments may be varied in structure, function, and implementation beyond the description provided. Signal processing engine 406 is not limited to the descriptions provided.

In some embodiments, signal processing engine 406 may include an audio enhancement engine module (not shown). An audio enhancement engine module processes signals to enhance characteristics of audio content such as the spectral envelope, frequency, pitch, tone, balance, noise and other audio characteristics. Audio captured from a natural environment often includes environmental noise. Source and channel codecs used to encode the audio add further noise to the audio. Such noise are reduced and removed based on analysis of the audio content and models of the noise. The spectral characteristics of the audio may be modified using cascaded low pass and high pass filters for changing the spectral envelope, pitch and the tone of the audio.

Signal processing engine 406 may also include an audio transformation engine module (not shown) that transforms sampling rates, sample precision, channel count, and source coding formats of audio content. Sampling rate changes may involve interpolation and resampling of interpolated data while sample precision is modified by dithering using an optional interpolation step for increasing precision. The audio transformation engine module may also use amplitude and phase arithmetic to shift the location of sound sources in multi-channel audio content or increase or decrease the number of channels in the audio content. The audio transformation engine module may be used to convert the audio information between different source coding formats used by different audio systems. Further, the audio transformation engine module may provide high level transformations (e.g., modifying speech content to sound as though spoken by a different speaker or a synthetic character) or modifying music to substitute musical instruments (e.g., replace a piano with a guitar, and the like). These higher-level transformations may use speech, music, psychoacoustic and other models to interpret audio content and generate modified versions using techniques such as those described above.

Signal processing engine 406, in some embodiments, may include a visual imagery enhancement engine module. The visual imagery enhancement module enhances characteristics of visual imagery (e.g., brightness, contrast, focus, saturation, and gamma) and corrects aberrations (e.g., color and camera lens aberrations). Brightness, contrast, saturation, and gamma correction may be performed by using additive filters or histogram processing. Focus correction may be implemented using high-pass Wiener filters and blind-deconvolution techniques. Aberrations produced by camera optics such as barrel distortion may be resolved using two dimensional (2D) space variant filters. Aberrations induced by visual sensors may be corrected by modeling aberrations induced by the visual sensors and inverse filtering the distorted imagery.

In other embodiments, signal processing engine 406 may include a visual transformation engine module (not shown). A visual transformation engine module provides low-level visual imagery transformations such as color space conversions, pixel depth modification, clipping, cropping, resizing, rotation, spatial resampling, and video frame rate conversion. In some embodiments, color space transformation may be performed using color space transformation matrices (e.g., as defined by CCIR 601 standard, and others). Pixel depth modification uses dithering with an optional interpolation step for increasing pixel depth. Spatial or temporal resampling (i.e., frame rate conversion) may be performed by interpolating input data followed by resampling at the target rate. Primitive graphical operations (e.g., clipping, cropping) may be performed using functions such as bitBLT, which may be used for pixel block transfers. Other functions that may be performed by a visual transformation engine module include affine and perspective transformations (e.g., resizing, rotation), which use matrix arithmetic with the matrix representation of the affine or perspective transformation. The visual transformation engine module may also perform transformations that use automatic detection and correction of spatial orientation of content. Another visual transformation that may be performed by the visual transformation engine module is ‘stitching’ of multiple still images into larger images or higher resolution images. Stitching employs precision registration of still images or video frames based on the overlap of content between the images/frames or based on the continuation of features in the images/frames across the image/frame boundary. Spatial interpolation may be used to enable sub-pixel precision registration. Registered frames may be stitched together to form a larger image or interpolated and added together to form a high resolution image. Stitching enables the extraction of visual elements that span multiple images/frames.

In some embodiments, a recognition engine 408 that analyzes information in natural media formats (e.g., audio, still images, video, and others) to derive information in machine interpretable form is included. Recognition engine 408 may be implemented using customized software, hardware or firmware. Recognition engine 408 and its various embodiments may be varied in structure, function and implementation beyond the descriptions provided. Further, recognition engine 408 is not limited to the descriptions provided.

In some embodiments, recognition engine 408 may include an Optical Character Recognition (OCR) engine module (not shown), which extracts information on text and symbols embedded in visual imagery. The extracted information may include text and symbols and formatting attributes (e.g., font, color, size, style, emphasis), layout information (e.g., organization into a hierarchy of characters, words, lines and paragraphs, positions relative to other text and boundaries). An OCR engine module may use image binarization, identification and extraction of features (e.g., text regions), and pattern recognition (e.g., using Bayesian logic or neural networks) to generate textual information from the visual imagery. In some embodiments, more than one OCR engine may be used (i.e., in parallel) and recognition results may be aggregated using a voting or weighting mechanism to improve recognition accuracy.

In some embodiments, recognition engine 408 may include a generalized visual recognition engine module configured to extract information such as the shape, texture, color, size, position, and motion of any logos and icons embedded in visual imagery. The generalized visual recognition engine module (not shown) may also be configured to extract information regarding the shape, texture, color, size, position, and motion of different regions in the visual imagery. Visual imagery may be segmented or isolated into regions using techniques such as edge detection and morphology. Characteristics of the regions may be extracted using localized feature extraction algorithms.

Recognition engine 408 may also include a voice recognition engine module (not shown). A voice recognition engine module may be implemented to evaluate the probability of a voice in audio content belonging to a particular speaker. Analysis of audio characteristics (e.g., spectrum frequencies, amplitude, modulation, and the like) and psychoacoustic models of speech generation may be used to determine the probability.

In some embodiments, recognition engine 408 may also include a speech recognition engine module (not shown) that converts spoken audio content to a textual representation. Speech recognition may be implemented by segmenting speech into phonemes, which are compared against dictionaries of phonetic sequences for words in a language. In other embodiments, the speech recognition engine module may be implemented differently.

In other embodiments, recognition engine 408 may include a music recognition engine module (not shown) that is configured to evaluate the probability of a musical score in audio content being identical to another musical score (e.g., a song pre-recorded and stored in a database or accessible through a music knowledge base). Music recognition involves generation of a signature for segments of music based on spectral properties. Music recognition may also involve knowledge of music generation (i.e., construction of music) and comparison of a signature for a given musical score against signatures of other musical scores (e.g., stored as data in a library or database).

In still further embodiments, recognition engine 408 may include a generalized audio recognition engine module (not shown). A generalized audio recognition engine module analyzes audio content and generates parameters that define audio content based on spectral and temporal characteristics, such as those described above.

In some embodiments, synthesis engine 410 generates information in natural media formats (e.g., audio, still images, and video) from information in machine-interpretable formats. Synthesis engine 410 and its various embodiments may be varied in structure, function, and implementation beyond the description provided. Synthesis engine 410 is not limited to the descriptions provided.

Synthesis engine 410 may include a graphics engine module or an image-based rendering engine module configured to render synthetic visual scenes from machine-interpretable definitions of visual scenes.

Graphical content generated by a graphics engine module may include simple graphical marks (e.g., primitive geometric figures, icon bitmaps, logo bitmaps, etc.) and complete 2D and 3D graphical objects. Graphical content generated by a graphics engine module may be presented as standalone content on a client user interface or integrated with captured visual imagery to form an augmented reality representation (i.e., images overlaid on other images). For example, enclosing rectangles may be overlaid on top of captured visual imagery to delineate the various contexts. In some embodiments, graphics engine module may generate graphics of different spatial and color space resolutions and dimensions to suite the presentation capabilities of client 402. Further, the functionality of the graphics engine module may also be distributed between client 402 and system server 106 to distribute the processing required to generate the graphics content, to make use of any special graphics processing capabilities available on client devices or to reduce the volume of data exchanged between client 402 and system server 106.

In some embodiments, synthesis engine 410 may include an Image-Based Rendering (IBR) engine module (not shown). As an example, an IBR engine may be configured to render synthetic visual scenes by interpolating and extrapolating still images and video to yield volumetric pixel data. An IBR engine module may be used to generate photorealistic renderings for seamless incorporation into visual imagery for realistic augmentation of the visual imagery.

In some embodiments, synthesis engine 410 may include a speech synthesis engine module (not shown) that generates speech from text, outputting the speech in a natural audio format. Speech synthesis engine modules may also support a number of voices or personalities that are parameterized based on the pitch, intonations, and other audio and vocal characteristics of the synthesized speech.

In some embodiments, synthesis engine 410 may include a music synthesis engine module (not shown), which is configured to generate musical scores in a natural audio format from textual or musical score input data. For example, MIDI and MPEG-4 Structured Audio synthesizers may be used to generate music from machine-interpretable musical scores.

In some embodiments, database 412 is included in system server 106. In other embodiments, database 412 is implemented as an external component and interfaced to system server 106. Database 412 may be configured to store data for system management and operation. Database 412 may also be configured to store data used to generate and provide information services. Knowledge bases that are internal to system 100 may be part of database 412. In some embodiments, the databases themselves may be implemented using a Relational Database Management System (RDBMS). Other embodiments may use Object-Oriented Databases (OODB), Extensible Markup Language Database (XMLDB), Lightweight Directory Access Protocol (LDAP) and/or other systems.

In some embodiments, external information services interface 414 enables application engine 416 to access information services provided by external sources. External information services may include communication services and information services derived from databases. In some embodiments, externally-sourced communication services may include, but are not limited to, voice telephone calls, video telephony calls, SMS, instant messaging, emails and discussion boards. Externally-sourced database derived information services may include, but are not limited to, information services that may be found on the Internet (e.g., Web search, Web storefronts, news feeds and specialized database services such as Lexis-Nexis and others).

Application engine 416 executes logic that interprets commands and messages from client 402 and generates an appropriate response by orchestrating other components in system server 106. Application engine 416 may be configured to interpret messages received from client 402, compose response messages to client 402, interpret commands in user inputs, forward natural media content to signal processing engine 406 for processing, forward natural media content to recognition engine 408 for conversion into machine interpretable form, forward information in machine interpretable form to synthesis engine 410 for conversion to natural media formats, store, retrieve and modify information from databases, access information services from sources external to system server 106, establish communication service sessions, and determine actions for orchestrating the above-described features and components.

Application engine 416 may be configured to use signal processing engine 406 to enhance information in natural media format. Application engine 416 may also be configured to use recognition engine 408 to convert information in natural media formats to machine interpretable form, generate contexts from available context constituents, and identify information services relevant to contexts from information stored in databases 412 integrated into the system server 106 and from external information services. Application engine 416 may also convert user inputs in natural media formats to machine interpretable form using recognition engine 408. For instance, user input in audio form may be converted to textual form using the speech recognition module integrated into the recognition engine 408 for processing spoken commands from the user. Application engine 416 may also be configured to convert information services from machine readable form to natural media formats using synthesis engine 410. Further, application engine 416 may be configured to generate and communicate response messages to client 402 over communication network 104. Additionally, application engine 416 may be configured to update client logic over communication network 104. Application engine 416 may be implemented using programming languages such as Java or C++ and software environments such as Java J2EE or Microsoft™.Net platforms.

Client device 102 communicates with system server 106 over communication network 104. Communication network 104 may be implemented using a wired network technology such as Ethernet, cable television network (DOCSIS), phone network (xDSL) or fiber optic cables. Communication network 104 may also use wireless network technologies such as cable replacement technologies such as Wireless IEEE 1394, Personal Area Network technologies such as Bluetooth™, Local Area Network (LAN) technologies such as IEEE 802.11x, Wide Area Network (WAN) technologies such as GPRS, EDGE, UMTS, CDMA 1x, CDMA 1x EV-DO, CDMA 1x EV-DV, IEEE 802.x networks or their evolutions. Communication network 104 may also be implemented as an aggregation of one or more wired or wireless network technologies.

In some embodiments, communication network 104 may include a number of components that enable the transportation and delivery of data through the network. The network components, which may be described using the Internet Engineering Task Force (IETF) network model, including appropriate signaling schemes to match the properties of the physical media over which a signal is transmitted. In addition, network components may also include error detection and correction schemes, communication session management and synchronization protocols and other advanced features such as data encryption and compression. Further, advanced communication networks may also provide automatic caching of data as in a Content Delivery Network and sub-network interfacing in case of heterogeneous networks that use different mechanisms for the various layers in the IETF model. In some embodiments, client 402 and system server 106 may use various data communication protocols e.g., HTTP, ASN.1 BER, .Net, XML, XML-RPC, SOAP, Web Services and others. In other embodiments, a system specific protocol may be layered over a lower level data communication protocol (e.g., HTTP, TCP/IP, UDP/IP, or others). In some other embodiments, data communication between client 402 and system server 106 may be implemented using SMS, WAP push or a TCP/UDP session initiated by system server 106.

In some embodiments, client device 102 communicates over a cellular network to a cellular base station, which in turn is connected to a datacenter housing system server 106 through the Internet. Data communication may be implemented using cellular communication standards such as Generalized Packet Radio Service (GPRS), UMTS or CDMA2000 1x. The communication link from the base station to the datacenter may be implemented using a heterogeneous wireless and wired networks. As an example, system server 106 may connect to an Internet backbone termination in a datacenter using an Ethernet connection. This heterogeneous data path from client device 102 to the system server 106 may be unified through use of the TCP/IP protocol across all components. Hence, in some embodiments, data communication between client device 102 and the system server 106 may use a system specific protocol overlaid on top of the TCP/IP protocol, which is supported by client device 102, the communication network and the system server 106. In other embodiments, where data is transmitted more asynchronously, a protocol such as UDP/IP may be used.

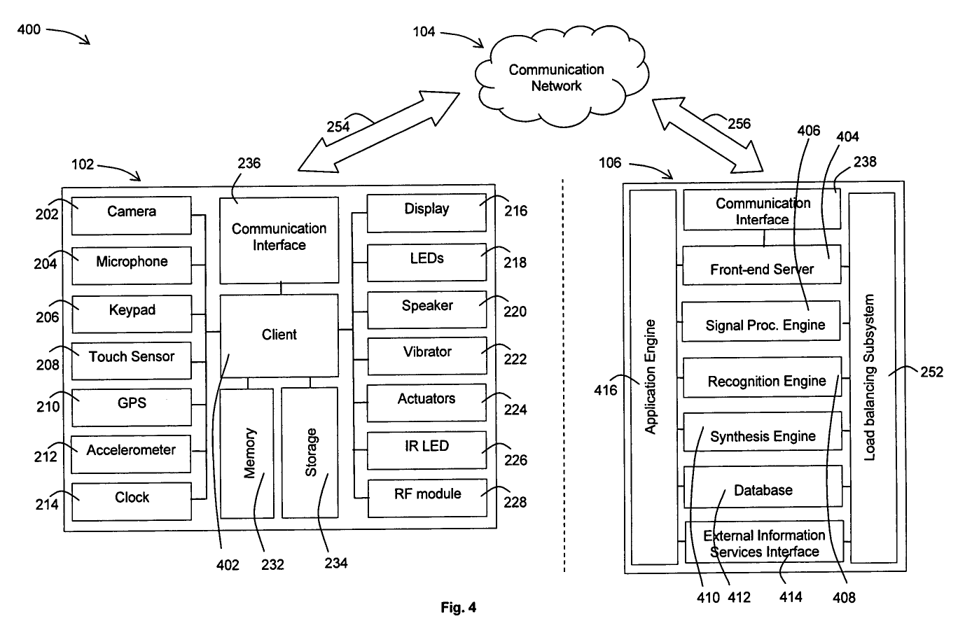

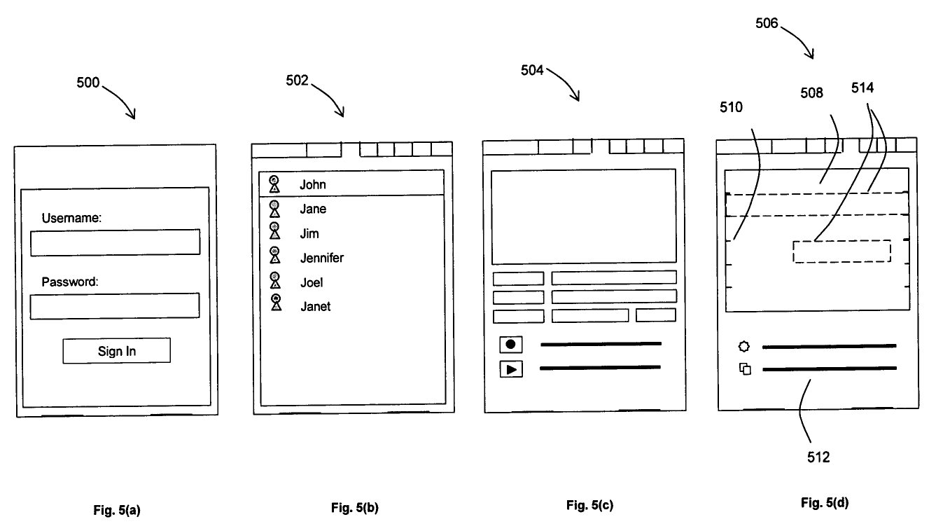

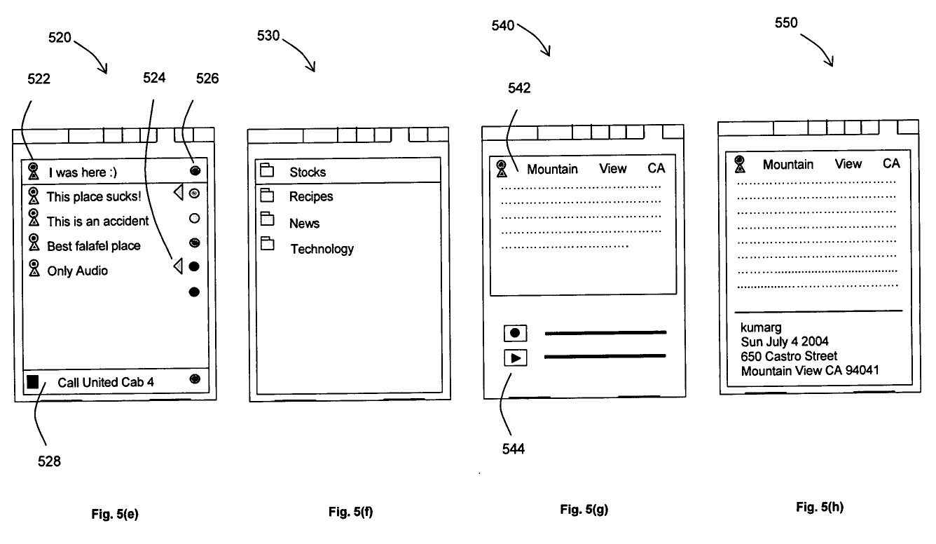

In some embodiments, client 402 generates and presents visual components of a user interface on display 216. Visual components of a user interface may be organized into the Login, Settings, Author, Home, Search, Folder and Content views as shown in the FIGS. 5(a)-(h). User interface views shown in FIGS. 5(a)-5(h) may also include commands on popup menus that perform various operations presented on a user interface.

FIG. 5(a) illustrates an exemplary Login view of the client user interface, in accordance with an embodiment. Here, Login view 500 enables a user to enter a textual user identifier and password. In other embodiments, different login techniques may be used.

FIG. 5(b) illustrates an exemplary Settings view of the client user interface, in accordance with an embodiment. Here, Settings view 502 provides an example of a user interface that may be used to configure various settings including user-definable parameters on client 402 (e.g., user groups, user preferences, and the like).

FIG. 5(c) illustrates an exemplary Author view of the client user interface, in accordance with an embodiment. Here, Author view 504 presents a user interface that a user may use to modify, alter, add, delete, or perform other information and information service authoring operations on client 402. In some embodiments, Author view 504 enables a user to create new information services or set access privileges for information services.

FIG. 5(d) illustrates an exemplary Home view of the client user interface, in accordance with an embodiment. Here, Home view 506 may display visual imagery captured by the camera 202 or visual imagery retrieved from storage 234 on viewfinder 508. Home view 506 may also include reference marks 510, which may be used to aid users in capturing live visual imagery (i.e., evaluation of size, resolution, orientation, and other characteristics of the imagery being captured). By aligning text in viewfinder 508 to the reference marks 510 through rotation and motion of the camera relative to the scene being imaged and by ensuring the text is at least as tall as the vertical gap between the reference marks, users may ensure capture of visual imagery of text for optimal functioning of the system. Home view 506 may also include textual and graphical indicators 512 of characteristics of visual imagery (e.g., brightness, focus, rate of camera motion, rate of motion of objects in the visual imagery and others).

In some embodiments, context constituents identified in the visual imagery may also be demarcated with graphical marks 514 in the viewfinder. The position of graphical marks relative to the visual imagery may also be compensated to account for motion of the camera used to capture the visual imagery or the motion of objects in the visual imagery themselves. This enables the presentation of graphical marks in spatial alignment with the visual imagery. Graphical marks 514 that define the context constituents may be in the form of rectangles surrounding the context constituents, a change in the hue, saturation or brightness of the area in and around the context constituents, change in the font and emphasis of textual elements, icons placed near the context constituents, or other such marks.

FIG. 5(e) illustrates an exemplary Search view of the client user interface, in accordance with an embodiment. Here, Search view 520 displays a list of information services relevant to a given context. Further, Search view 520 also presents metadata associated with information services. Metadata may include author relationship 522 (i.e., categorization of the author of information services such as self, friend or third party), spatial distance 526 (i.e., spatial distance of client device 102 (FIG. 1) from entities such as the information service, the author of the information service, the provider of the information service, the location of authoring of the information service and the like), media types 524 (i.e., media types used in information services), and nature of information services 528 (i.e., the sponsored, commercial or regular nature of information services). The metadata may be presented in Search view 520 using textual representations or graphical representations such as special fonts, icons and colors and the like.

FIG. 5(f) illustrates an exemplary Folder view of the client user interface, in accordance with an embodiment. Here, Folder view 530 displays the organization of a hierarchy of folders. The hierarchy of folders may be used to classify information services or information associated with information services.

FIG. 5(g) illustrates an exemplary Content view of the client user interface, in accordance with an embodiment. Here, Content view 540 is used to present and control information services (which include communication services). The Content view may incorporate user interface controls for the presentation and control of textual information 542 and user interface controls for the presentation and control of multimedia information 544. The multimedia information is presented through appropriate output components integrated in to client device 102 such as speaker 220. Information presented in Content view 550 may include authoring information (e.g., author, time, location, and the like of the authoring of an information service or the information associated with an information service).

FIG. 5(h) illustrates an exemplary Content view of the client user interface, in accordance with an embodiment. Here, Content view 550 is presented using minimal number of user interface graphical widgets. Such a rendering of the Content view enables presentation of large amounts of information on client devices 102 with small displays 216.

In some embodiments, the system specific communication protocol, which is overlaid on top of other protocols relevant to the underlying communication technology used, follows a request-response paradigm. Communication is initiated by client 402 with a request message to system server 106 for which system server 106 responds with a response message effectively establishing a “pull” model of communication. In other embodiments, client-system server communication may be implemented using “push” model-based protocols such as Short Message Service (SMS), Wireless Access Protocol (WAP) push or a system server 106 initiated TCP/IP session terminated at client 402.

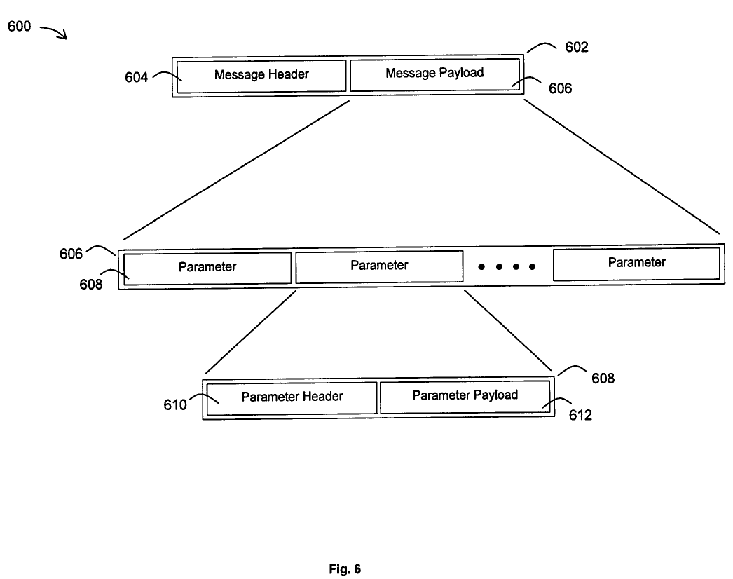

FIG. 6 illustrates an exemplary message structure for the communication protocol specific to the system. Here, message structure 600 is used to implement a system specific communication protocol. Message 602 includes message header 604 and message payload 606. Message payload 606 may include one or more parameters 608. Each of parameters 608 may further include parameter header 610 and parameter payload 612. Structures 602-612 may be implemented as fields of data bits or bytes, where the number, position, and type of bits (e.g., “0” or “1”) may be used to instantiate a given value. Data bits or bytes may be used to represent numerical, text or binary values. In some embodiments, message 602 may be transported using a standard protocol such as HyperText Transfer Protocol (HTTP), .Net, eXtensible Markup Language-Remote Protocol Call (XML-RPC), XML over HTTP, Simple Object Access Protocol (SOAP), Web Services or other protocols and formats. In other embodiments, message 602 is encoded into a raw byte sequence to reduce protocol overhead, which may slow down data transfer rates over low bandwidth cellular communication channels. In this example, messages may be directly communicated over TCP or UDP.

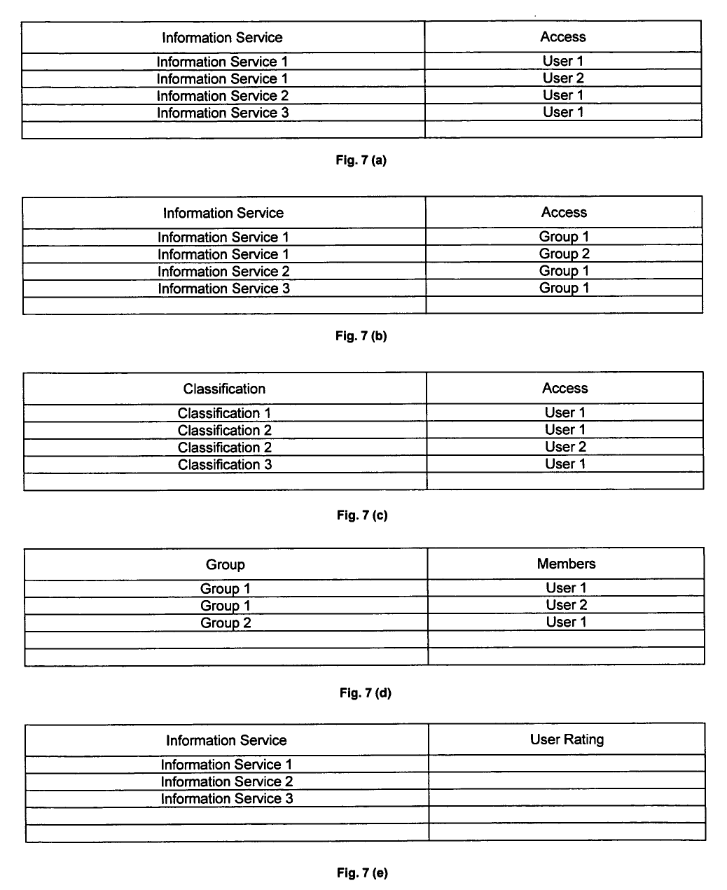

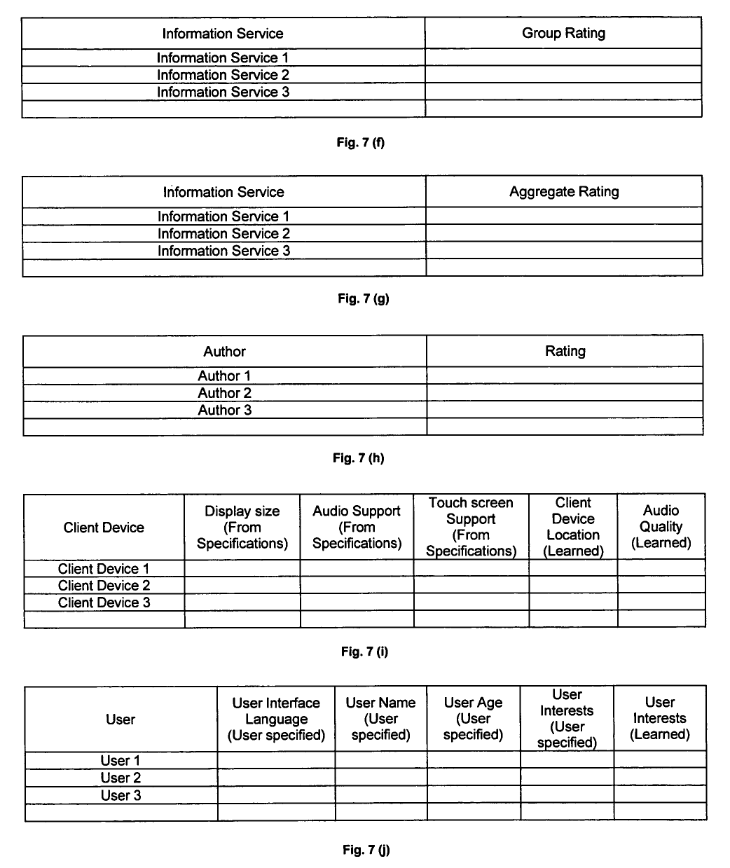

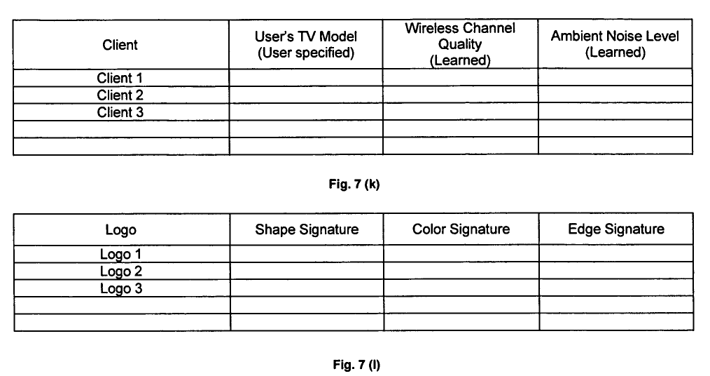

FIGS. 7(a)-7(l) illustrate exemplary structures for tables used in database 412. The tables illustrated in FIGS. 7(a)-7(l) may be data structures used to store information in databases and knowledge bases. The definition of the tables illustrated in FIGS. 7(a)-7(l) is to be considered representative and not comprehensive, since the database tables can be expanded to include additional data relevant to delivering information services. For complete system operation, system 100 may use one or more additional databases though they may not be explicitly defined here. Further, system 100 may also use other data structures to organize and store information such as that described in FIGS. 7(a)-7(l). Data normalization may result in structural modification of databases during the operation of system 100.

FIG. 7(a) illustrates an exemplary user access privileges table, in accordance with an embodiment. Here, access privileges of users to various information services provided by the system 100 are listed. In some embodiments, the illustrated table may be used as a data structure to implement a user information service access privileges database.

FIG. 7(b) illustrates an exemplary user group access privileges table, in accordance with an embodiment. Here, access privileges of users to various user groups in the system 100 are listed. In some embodiments, the illustrated table may be used as a data structure to implement a user group information service access privileges database.

FIG. 7(c) illustrates an exemplary information service classifications table, in accordance with an embodiment. Here, classifications of information services as performed by the system 100 and as performed by users of the system 100 are listed. In some embodiments, the illustrated table may be used as a data structure to implement an information services classification database.

User access privileges for information services, user groups, and information service classifications may be stored in data structures such as those shown in FIGS. 7(a)-7(c), respectively. Access privileges may enable a user to create, edit, modify, or delete information services, information included in information services, and other data (e.g., user groups, information services classifications, and the like).

FIG. 7(d) illustrates an alternative exemplary user groups table, in accordance with an embodiment. Here, the illustrated table lists various user group memberships. Additionally, privileges and roles of members (i.e., users) in a user group may be listed based on access privileges available to each user. Access privileges for each user may allow some users to author information while others own information. In some embodiments, users may also have access privileges to enable them to moderate user groups for the benefit of other members of a user group. In some embodiments, the illustrated table may be used as a data structure to implement a user groups database.

FIG. 7(e) illustrates an exemplary information services ratings table listing individual users, in accordance with an embodiment. Here, the ratings for information services in the illustrated table may be derived from the time spent by individual users of system 100 using an information service or from information service ratings explicitly specified by the users of system 100. In some embodiments, the illustrated table may be used as a data structure to implement an information services user ratings database.

FIG. 7(f) illustrates an exemplary information services ratings table listing user groups, in accordance with an embodiment. Here, the ratings for information services in the illustrated table may be derived from the time spent by members of a user group of system 100 using an information service or from information service ratings explicitly specified by the members of a user group of system 100. In some embodiments, the illustrated table may be used as a data structure to implement an information services user groups ratings database.

FIG. 7(g) illustrates an exemplary aggregated information services ratings table for users and user groups, in accordance with an embodiment. Here, the ratings for information services in the illustrated table may be derived from the aggregated time spent by users of system 100 and members of user groups of system 100 using an information service or from information service ratings explicitly specified by users of system 100 and members of user groups of system 100. In some embodiments, the illustrated table may be used as a data structure to implement an information services aggregated ratings database.

FIG. 7(h) illustrates an exemplary author ratings table, in accordance with an embodiment. Here, the popularity of contributing authors who provide information services to system 100 is listed in the illustrated table. In some embodiments, author popularity may be determined by aggregating the popularity of information services to which an author has contributed. In other embodiments, an author's popularity may be determined using author ratings specified explicitly by users of system 100. In some embodiments, the illustrated table may be used as a data structure to implement an author ratings database.

FIG. 7(i) illustrates an exemplary client device characteristics table, in accordance with an embodiment. Here, the illustrated table lists characteristics (i.e., explicitly specified or system-learned characteristics) of client device 102. In some embodiments, explicitly specified characteristics may be determined from user input. Explicitly specified characteristics may include user input entered on a client user interface and characteristics of client device 102 derived from the specifications of the client device 102. System-learned characteristics may be determined by analyzing a history of characteristics for client device 102, which may be stored in a knowledge base. Examples of characteristics derived from device specifications may include the display size, audio presentation and input features. System-learned characteristics may include the location of client device 102, which may be derived from historical location information uploaded by client device 102. System-learned characteristics may also include audio quality information determined by analyzing audio information authored using client device 102. In some embodiments, the illustrated table may be used as a data structure to implement a client device characteristics knowledge base.

FIG. 7(j) illustrates an exemplary user profile table, in accordance with an embodiment. Here, the illustrated table may be used to organize and store user preferences and characteristics. User preferences and characteristics may be either explicitly specified or learned (i.e., learned by system 100). In some embodiments, explicitly specified preferences and characteristics may be input by a user as data entered on the client user interface. Learned preferences and characteristics may be determined by analyzing a user's historical preference selections and system usage. Explicitly specified preferences and characteristics may include a user's name, age, and preferred language. Learned preferences and characteristics may include user interests or ratings of various information services, classifications of information services (classifications created by the user and classifications used by the user), user group memberships, and individual user classifications. In some embodiments, the illustrated table may be used as a data structure to implement a user profiles knowledge base.

FIG. 7(k) illustrates an exemplary environmental characteristics table, in accordance with an embodiment. Here, the illustrated table may include explicitly specified and learned characteristics of the client device's environment. Explicitly specified characteristics may include characteristics specified by a user on a client user interface and specifications of client device 102 and communication network 104. Explicitly specified characteristics may include the model of a user's television set used by client 402, which may be used to generate control signals to the television set. Learned characteristics may be determined by analyzing environmental characteristic histories stored in an environmental characteristics knowledge base. In some embodiments, learned characteristics may include data communication quality over communication network 104, which may be determined by analyzing the history of available bandwidth, rates of communication errors, and ambient noise levels. In some embodiments, ambient noise levels may be determined by measuring noise levels in visual and audio content captured by client 402. In some embodiments, the illustrated table may be used as a data structure to implement an environmental characteristics knowledge base.

FIG. 7(l) illustrates an exemplary logo information table, in accordance with an embodiment. In some embodiments, data regarding logos and features extracted from logos may be stored in the illustrated table. Specialized image processing algorithms may be used to extract features such as the shape, color and edge signatures from logos. The extracted information may be stored in the illustrated table as annotative information associated with the logos. In some embodiments, the illustrated table may be used as a data structure to implement a logo information database.

FIGS. 7(a)-(l) illustrate exemplary structures for tables used in databases and knowledge bases in some embodiments. In other embodiments, databases and knowledge bases may use other data structures to achieve similar functionality. In addition to knowledge bases using tables illustrated in FIGS. 7(a)-(l), system server 106 may also include knowledge bases such as a language knowledge base (i.e., a knowledge base that defines the grammar, syntax and semantics of languages), a thesaurus knowledge base (i.e., a knowledge base of words with similar meaning), a Geographic Information System (GIS) (i.e., a knowledge base providing mapping information for generating geographical maps and cross referencing postal and geographical addresses), an ontology knowledge base (i.e., a knowledge base of classification hierarchies of various knowledge domains) and the like.

Operation

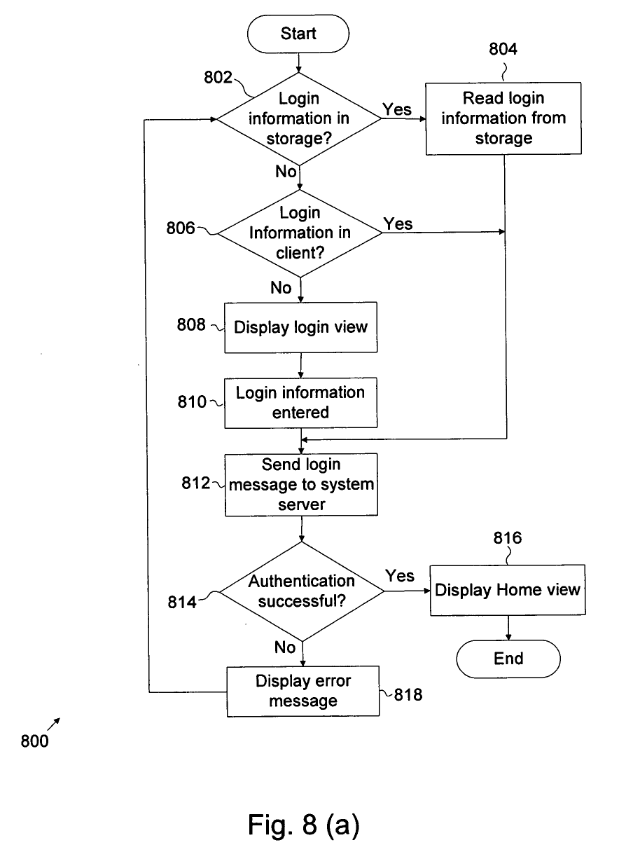

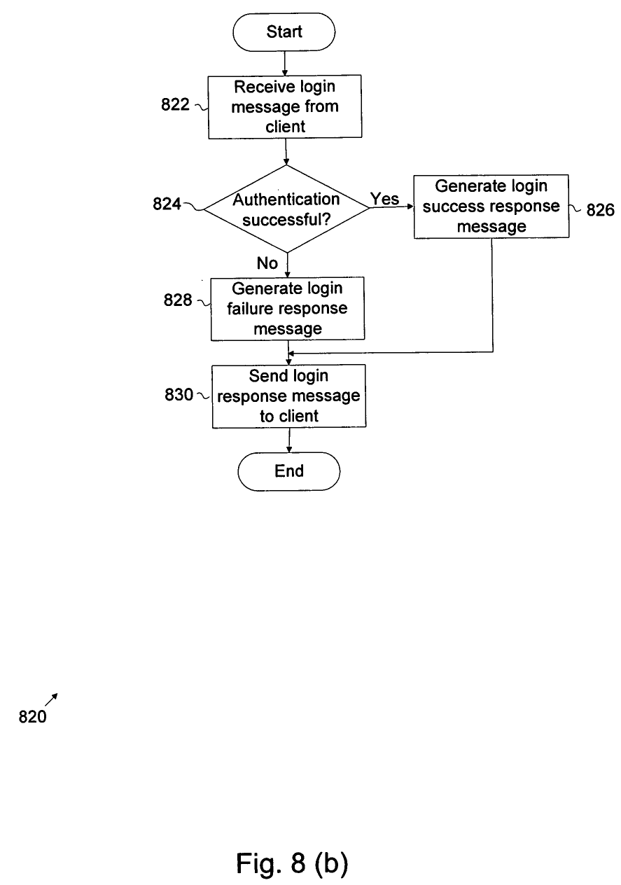

FIG. 8(a) illustrates an exemplary process for starting a client, in accordance with an embodiment. Here, an evaluation is made as to whether login information is stored on client device 102 (802). If login information is stored, then the information is read from storage 234 on client device 102 (804). If login information is not available in storage 234 on client device 102, another determination is made as to whether login information is embedded in client 402 (806). If information is not embedded in client 402, then a login view is displayed on client 402 (808). Login information is entered by a user (810). Once the login information is obtained by client 402 from storage, client embedding or user input, a login message is generated and sent to system server 106 (812). Upon receipt, system server 106 authenticates the login information and sends a response message with the authentication status. (814). Login information may include a textual identifier (e.g., user name, password), a visual identifier (e.g., visual imagery of a user's face) or an audio identifier (e.g., user's voice or speech). If authentication is successful, the home view of the client 402 user interface may be displayed (816) on display 216. If authentication fails, then an error message may be displayed (818). In other embodiments, process 800 may be varied and is not limited to the above description.

A user interacts with the system 100 through client 402 integrated into client device 102. User launches client 402 by selecting client 402 and launching it using a native user interface of client device 102. Client device 102 may also be configured to launch client 402 automatically upon clicking a specific key or upon power-up activation.

Upon launching, client 402 presents a login view of a user interface to a user on display 216 on client device 102 for entering a login user identification and password as shown in FIG. 5(a). Referring back to FIG. 8(a), upon user entry of information, client 402 initiates communication with system server 106 by opening a TCP/IP socket connection to system server 106 using the TCP/IP stack integrated into client device 102 software environment. Client 402 then composes a Login request message including the user identification and password as parameters. Client 402 then sends the request message to system server 106 to authenticate and authorize a user's privileges in the system. Upon verification of a user's privileges, system server 106 responds with a Login response message indicating successful login of the user. Likewise, the system server 106 responds with a Login response message indicating failure of the login, if a login attempt was unsuccessful (i.e., invalid user identification or password was presented to the system server 106). In some embodiments, a user may be prompted to attempt another login. Authentication information may also be stored locally on client 402 or embedded in client 402, in which case, the user does not have to explicitly enter the information.

FIG. 8(b) illustrates an exemplary process for authenticating a client on system server 106, in accordance with an embodiment. Here, process 820 is initiated when a login message is received from client 402 (822). The received login message is authenticated by system server 106 (824). If the login information in the login message is authenticated, then a login success response message is generated (826). However, if the login information in the login message is not authenticated, then a login failure response message is generated (828). Regardless of whether a login success response message or a login failure response message is generated, the response message is sent to client 402 (830).

In some embodiments, authentication may be performed using a text-based user identifier and password combination. In other embodiments, audio or video input are used to authenticate users using appropriate techniques such as voice recognition, speech recognition, face recognition and/or other visual recognition algorithms. Authentication may be performed locally on client 402 or remotely on system server 106 or with the authentication process distributed over both client 402 and system server 106. Authentication may also be done with SSL client certificates or federated identity mechanisms such as Liberty. In some embodiments, authentication may be deferred to a later instant during the use, instead of at the launch of client 402. Further, explicit authentication may be eliminated if implicit authentication mechanisms (e.g., client/user identifier built into a data communication protocol or client 402) are available.

If a user is authenticated, client 402 presents the home view on display 216 as shown in FIG. 5(c). The home view may display captured visual imagery, similar to previewing a visual scene to be captured in a camera viewfinder. A user may point camera 202 at a scene of his choice and snap a still image by clicking on the designated camera shutter key on client device 102. In other embodiments, the camera shutter (i.e., the start of capture of visual imagery) may be triggered by clicking a designated soft key on client device 102, by selecting an option displayed on a touch sensitive display or by speaking a command into the microphone. To aid a user in choosing a size or zoom factor and the spatial orientation of the visual scene in the viewfinder that enables the optimal performance of the system, reference marks 510 may be superposed on the live camera imagery i.e. viewfinder. A user may move client device's 102 position relative to objects in the visual scene or adjust controls on the client 402 or client device 102 (e.g., adjust the zoom or spatial orientation) in order to align the captured imagery with the reference marks on the viewfinder. While the above discussion describes the capture of a still image, client 402 may also capture a sequence of still images or video. A user may perform a different interaction at the client user interface to capture sequence of still images or video. Such interaction may be the clicking of a designated physical key, soft key, touch sensitive display, a spoken command or a different method of interaction on the same physical key, soft key, or touch sensitive display used to capture a single still image. Such a multiple still image or video capture feature is especially useful in cases where the visual scene of interest is large enough so as not to fit into a single still image with sufficient spatial resolution for further processing of the imagery by system 100.

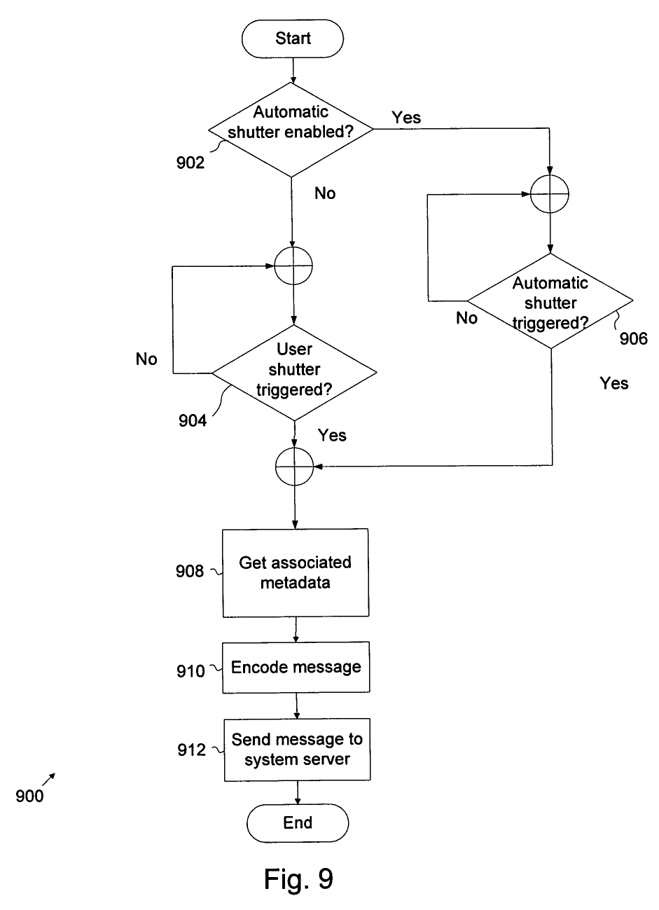

FIG. 9 illustrates an exemplary process for capturing visual information and starting client-system server interaction, in accordance with an embodiment. Here, a determination is made as to whether to use the user shutter triggered mode of operation or automatic shutter triggered mode of operation (902). Upon triggering of the shutter by the user (904), in the case of user triggered mode of operation or upon triggering of the shutter automatically by the system (906) in the case of automatic shutter triggered mode of operation, the metadata associated with the visual imagery is obtained by client 402 from the components of the client 402 and client device 102 (908). Then, the captured visual imagery is encoded (910) along with the associated metadata and communicated to the system server 106 (912). In other embodiments, process 900 may be varied and is not limited to the above description.

In the automatic shutter triggered mode of operation, the client captures visual imagery when a pre-defined criterion is met. Examples of pre-defined criteria include spatial proximity of the user and/or client device to a pre-defined location, a pre-defined time instant, a pre-defined interval of time, motion of the user and/or client device, spatial orientation of the client device, characteristics of the visual imagery (e.g., brightness, change in brightness, motion of objects in visual imagery, etc.), and other criteria defined by the user and system 100.

In some embodiments, the Home view of the user interface of client 402 may also provide indicators 512, which provide indicators of image quality such as brightness, contrast, and focus. Indicators 512 may also provide information or indications on the state of client device 102 such as its location, spatial orientation, motion, and time. Image quality parameters may be determined from the captured visual imagery displayed on the viewfinder and presented on the user interface. Likewise, the state information of client 402 obtained from internal logic states of client 402 are presented on the user interface. The image quality and client state indicators help a user capture visual imagery representative of the context or use intended by the user and also ensures that the captured visual imagery is suitable for processing by system 100. Capture of the visual imagery may also be controlled implicitly by monitoring pre-defined factors such as the motion of client device 102 or visual imagery displayed on the viewfinder or the clock 214 integrated into client device 102. In some embodiments, visual imagery retrieved from storage 234 may be presented on viewfinder 508.

Client 402 uses the visual imagery in conjunction with associated metadata and user inputs to compose a request message. The request message may include captured visual imagery encoded into a suitable format (e.g., JPEG, GIF, CCITT Fax, MPEG, H.26x) and associated metadata. In some embodiments, the encoding of the message and the information in the message may be customized to the available resources of client device 102, communication network 104 and system server 106. For example, in some embodiments where the data rate capacity of communication network 104 is very low, visual imagery may be encoded with reduced resolution and greater compression ratio for fast transmission over communication network 104. In other embodiments, where the data rate capacity of communication network 104 is greater, visual imagery may be encoded with greater resolution and lesser compression ratio. Further, in some embodiments, resource aware signal processing algorithms that adapt to the instantaneous availability of computing and communication resources in the client device 102, communication network 104 and system server 106 may be used. The message may be formatted and encoded per various data communication protocols and standards (e.g., the system specific message format described elsewhere in this document). Once encoded, the message is communicated to system server 106 through communication network 104.

Communication of the encoded message in an environment such as Java J2ME involves requesting the software environment to open a TCP/IP socket connection to an appropriate port on system server 106 and requesting the software environment to transfer the encoded message data through the connection. The TCP/IP protocol stack integrated into the software environment on client 402 and the underlying protocols built into communication network 104 components manage the delivery of the encoded message data to the system server 106.

In some embodiments, front-end server 404 on system server 106 receives the request message and forwards it to application engine 416 after verifying the integrity of the message. The message integrity verification includes the verification of the originating IP address to create a network firewall mechanism and verification of the structure of the contents of the message to identify corrupted data that may potentially damage application engine or cause dysfunction. Application engine 416 decodes the message and parses the message into its constituent parameters. Natural media data (e.g., audio, still images, and video) contained in the message is forwarded to signal processing engine 406 for decoding and enhancement. The processed natural media data is then forwarded to recognition engine 408 for extraction of recognizable elements embedded in the natural media data. Logic in application engine 416 uses machine-interpretable information obtained from recognition engine 408 along with metadata and user inputs embedded in the message and information from knowledge bases to construct contexts for the visual imagery. When more than one context constituent is available to generate contexts, application engine 416 may constitute a plurality of contexts through permutation and combination of the available context constituents.

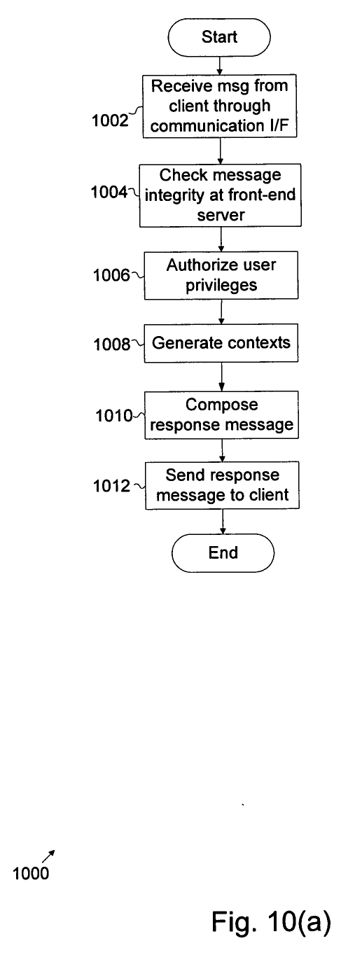

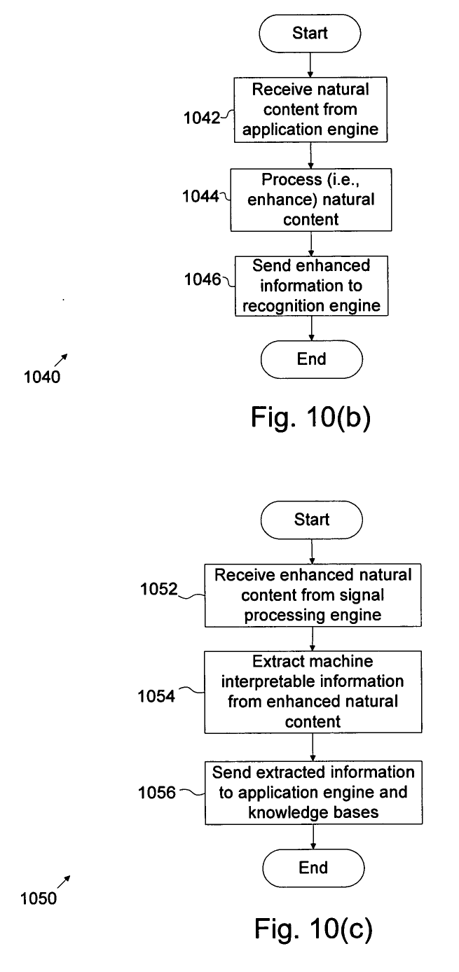

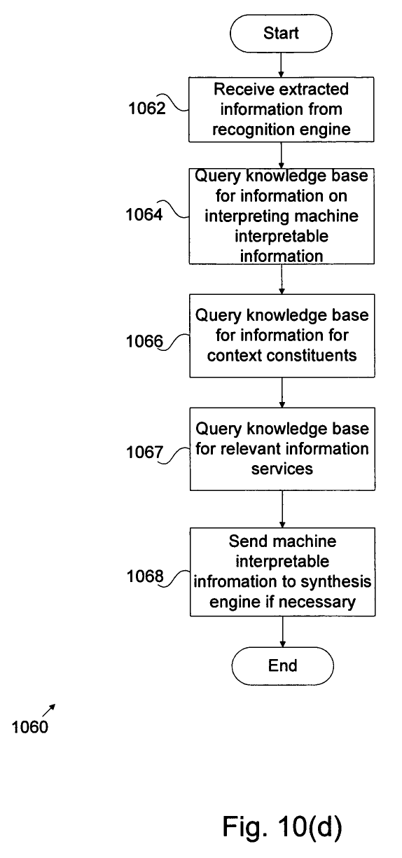

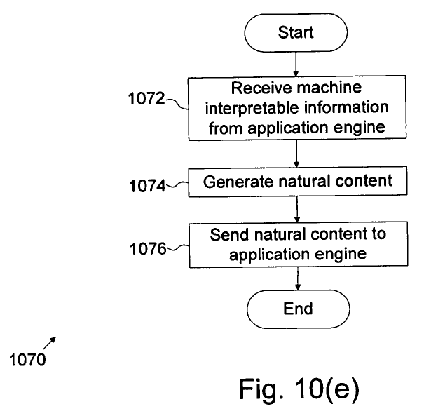

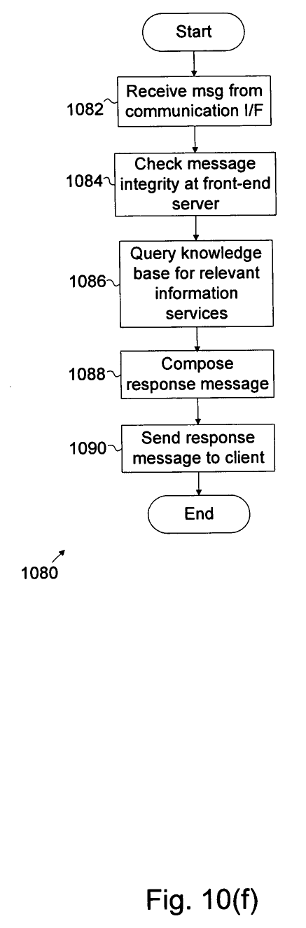

FIG. 10(a) illustrates an exemplary process for generating contexts, in accordance with an embodiment. Process 1000 is initiated when a message is received through communication interface 238 (1002). Once received, front-end server 404 checks the integrity of the received message (1004). Application engine 416 authorizes access privileges for the user upon authentication, as described above (1006). Once authorized, application engine 416 generates contexts as described above (1008). Additional processes that may be included in the generation of contexts are described below in connection with FIGS. 10(b)-10(f). Application engine 416 then generates or composes a response message containing the generated contexts (1010). Once generated, the response message is sent from system server 106 to client 402 (1012). In other embodiments, process 1000 may be varied and is not limited to the description provided above.

FIG. 10(b) illustrates an exemplary process for processing natural content by signal processing engine 406, in accordance with an embodiment. Process 1040 is initiated when natural content is received by signal processing engine 406 from application engine 416 (1042). Once received, the natural content is processed (i.e., enhanced) (1044). The signal processing engine 406 decodes and enhances the natural content as appropriate. The enhanced content is then forwarded to recognition engine 408 that extracts machine interpretable information form the enhanced natural content, which is described in greater detail below in connection with FIG. 10(c). Enhanced natural content is sent to recognition engine 408 (1046). Examples of enhancements performed by the signal processing engine include normalization of brightness and contrast of visual imagery. In other embodiments, process 1040 may be varied and is not limited to the above description.

FIG. 10(c) illustrates an exemplary process for extracting information from enhanced natural content by the recognition engine 408, in accordance with an embodiment. In process 1050, enhanced natural content is received from signal processing engine 406 by the recognition engine 408 (1052). Once received, machine-interpretable information is extracted from the enhanced natural content (1054) by the recognition engine 408. Examples of extraction of machine-interpretable information by recognition engine 408 include the extraction of textual information from visual imagery by an OCR engine module of the recognition engine 408. The extracted information (e.g., machine-interpretable information) may be sent to application engine 416 and relevant knowledge bases (1056). In other embodiments, process 1050 may be varied and is not limited to the descriptions given.

FIG. 10(d) illustrates an exemplary process for querying information from a knowledge base by the application engine 416, in accordance with an embodiment. In some embodiments, process 1060 is initiated when extracted machine-interpretable information is received (1062). The application engine 416 queries the knowledge base 412 for relevant knowledge (i.e., information) used in interpreting the machine interpretable information extracted by the recognition engine 408 (1064). After interpretation of the machine interpretable information, the application engine 416 queries the knowledge base 412 for information that is used as context constituents for the generation of contexts (1066). Once the contexts are generated, the application engine 416 queries the knowledge base 412 for information services that are relevant to the generated contexts (1067) The information and information services may also be sent to the synthesis engine 410 by the application engine 416 to generate natural content from machine interpretable content (1068). In other embodiments, process 1060 may be varied and is not limited to the above description.

FIG. 10(e) illustrates an exemplary process for generating natural content from machine interpretable information by synthesis engine 410, in accordance with an embodiment. Here, process 1070 is initiated when synthesis engine 410 receives machine interpretable information from the application engine 416 (1072). Natural content is generated by synthesis engine (1074) and sent to application engine 416 (1076). In other embodiments, process 1070 may be varied and is not limited to the description provided.

FIG. 10(f) illustrates an alternative exemplary process for providing information services in response to continued interaction with the client user interface by the user, in accordance with an embodiment. Here, process 1080 may be initiated when a message requesting one or more information services is received over communication interface 238 (1082). Front-end server 404 checks the data integrity of the received message (1084). Using the identifiers for the requested information services embedded in the request message, application engine 416 retrieves relevant information services from the knowledge base 412 (1086). Information services retrieved from the knowledge base 412 are then used to compose a response message (1088). The response message is then sent by the application engine 416 to client 402 (1090).

In other embodiments, different alternative processes may be implemented and variations of individual steps may be performed beyond those described above for processes described in connection with FIGS. 10(a)-10(f). In some embodiments, information services sourced from outside system 100 are routed through system server 106. In other embodiments, information services sourced from outside system 100 are obtained by client 402 directly from the source without the intermediation of system server 106.

For an example of the generation of multiple contexts through permutation and combination of a set of context constituents, consider the case where a textual visual element such as the name of a city is extracted from the visual imagery and the city is identified as belonging to a specific state in a country from the GIS database. In this example, at least three contexts may be composed from the available context constituents: 1) city name and city location, 2) city name and state location, and 3) city name and country location. Another example includes textual information embedded in a still image of a page of a book that may be extracted. The text may be composed of multiple paragraphs each including multiple sentences composed of multiple words. Embedded text extracted from visual imagery in conjunction with the knowledge base of the grammar, syntax and semantics of the language enable the generation of contexts for individual characters, individual words, and collections of words, phrases, individual sentences, entire paragraphs and the like. Further, the use of other context constituents such as location and time along with the textual information extracted from the page enables the definition of independent contexts for each character, word, sentence and paragraph in each space-time coordinate or zone. Such specialized definition of contexts enables the system 100 to provide information services customized to each context. In other embodiments, different contexts may be constructed from other available sets of context constituents with matching relevant information services.

In some embodiments, application engine 416 generates contexts by first compiling an available set of context constituents. The available set of context constituents may include the various overlapping hierarchies as in the case of the words, phrases, sentences and paragraphs in text extracted from visual imagery. Application engine 416 then constructs a list of prototype contexts through permutation and combination of the available set of context constituents. Each prototype context may contain one or more of the context constituents in various combinations. The prototype contexts are then filtered to eliminate prototype contexts of trivial value and create the list of contexts. The list of contexts is then prioritized by assigning a relevance factor to the contexts. In some embodiments, the relevance factor of a context is computed as a weighted average of the availability of information services relevant to the context and the implied meaning of the context. In other embodiments, the relevance factor may be computed using other statistical techniques and linear and non-linear mathematical models. Logic for inferring the implied meaning of a context may be included in application engine 416 and may be in the form of a rule library listing typical context constructs. Further, it is to be noted that since a plurality of contexts is generated from an available set of context constituents, substantially similar contexts may be generated from different sets of context constituents yielding identical sets of relevant information services. For example, the text “Sony Television” extracted from visual imagery of a paper catalog and the text “Sony Television” extracted from visual imagery of a billboard may generate similar sets of contexts. Contexts and hence associated information services are identified based on visual elements irrespective of the physical objects from which the context constituents are sourced.

In some embodiments, knowledge bases may also be used to infer additional implicit knowledge from the available set of context constituents. Inferred implicit knowledge may be used with other context constituents to form a larger set of context constituents for generation of contexts. For example, information entities with distinct syntax and semantics (e.g., telephone numbers, postal addresses, email addresses, and World Wide Web URLs) may be automatically recognized from the available set of context constituents using knowledge of the syntax and semantics of such information entities and their typical values or contents. Another example is the interpretation of an extended length of text extracted from visual imagery as words, a set of words, sentences and paragraphs using a knowledge base of grammar, syntax and semantics of the language.

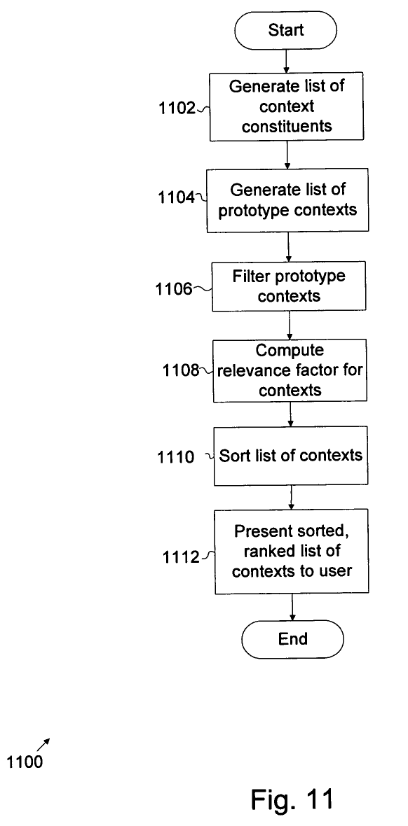

FIG. 11 illustrates an exemplary process for generating contexts by application engine 416, in accordance with an embodiment. Process 1100 is initiated by generating a list of context constituents (1102). Context constituents may include machine interpretable representations of visual elements extracted from visual imagery, metadata associated with the visual imagery, user inputs and information derived from knowledge bases. Context constituents may be generated as described above. A list of prototype contexts is then generated (1104). A list of prototype contexts may be generated through permutation and combination of available context constituents, where each prototype context may by comprised of one or more constituents. From a set of n context constituents,

$${\sum }_{r = 1}^{n} n P r$$

prototype contexts may be generated, where P is the mathematical permutation operator and r is the number of context constituents used in a given context.

Once generated, the list of prototype contexts is filtered to remove entries with low relevancy to the available set of context constituents (1106). As an example, a prototype context consisting of just the article “a” in English textual information may be removed. Another example of a prototype context that may be filtered is the color for a region of a captured visual image. The subset of prototype contexts generated by the filtering operation forms the final set of contexts.

Once the list of contexts is available, a relevance factor is assigned to each of the contexts (1108). A relevance factor may be generated (i.e., computed) and assigned to each context as a measure of its importance or usefulness to a user. A relevance factor may be computed using linear or non-linear mathematical models or rule based models. For example, a relevance factor may be computed as a weighted average of factors (e.g., availability of information services relevant to the context, availability of sponsored information services relevant to the context, narrowness of the context and users' interests in the different classifications of information services and others). The weighted average relevance factor of a context r_{c} may be determined using the following formula.

$${r}_{c} = \frac{{\sum }_{i} {w}_{i} {q}_{i}}{{\sum }_{i} {w}_{i}}$$

where wᵢ is the weight associated with constituent i and qᵢ is a quantitative metric of the value of constituent i of the context. The quantitative metric of the value (qᵢ) for constituents derived from structured information such as size, spatial location or time is obtained using linear metrics. The quantitative metric of the value (qᵢ) for constituents derived from unstructured information, such as text, is customized for each type of constituent. The quantification of the value of such constituents relies on hints derived from ontologies applicable to unstructured information and domain-specific knowledge applicable to the unstructured information. In some embodiments, the quantification process may use classification techniques such as neural networks, clustering or genetic algorithms, and statistical techniques such as Hidden Markov Model or Latent Semantic Analysis. For example, the quantitative value of a word compared to an adjacent word or a collection of words is derived based on the meaning of words and phrases as defined in a database of language grammar, syntax and semantics.

Following the computation of the relevance factor for each context, in some embodiments, the list of contexts may be sorted in descending order of relevancy (1110). In other embodiments, the list may be sorted in different order. The sorted list of contexts may be presented to the user (1112). In other embodiments, process 1100 may be varied differently and is not limited to the above description.

As an example, where a single context is generated from the available context constituents, application engine 416 generates a list of information services relevant to the single context for presentation on client 402 from a database of information services and encapsulates the list of information services in a response message. The response message communicated to client 402 may be formatted and encoded using a protocol such as that illustrated in FIG. 6. The encoded response message is communicated to client 402. Client 402 decodes the response message and presents information services on client 402 user interface. A user then browses the information service options presented on a user interface on client 402.

As another example, where a multitude of contexts are generated from the available context constituents, application engine 416 may generate a list of contexts for presentation on client 402 and encapsulate the list of generated contexts in a response message. The response message communicated to client 402 is formatted and encoded using a protocol such as that illustrated in FIG. 6. The encoded response message is then communicated to client 402. A user browses the list of contexts presented to him on the user interface on client 402 and selects one or more of the contexts to retrieve information services relevant to the selected contexts. Client 402 transmits the request for information services to system server 106, which returns the list of relevant information services from a database of information services. A user then browses the information service options presented on the user interface of the client 402.

In still another example, when a multitude of contexts are generated from available context constituents, application engine 416 generates graphical representations of the contexts, For example, in the form of rectangles, enclosing context constituents in the visual imagery that are used in each context. These graphical representations of contexts are presented to a user as a graphical menu overlaid on top of the captured visual imagery offering an augmented reality representation of the visual imagery. The graphical overlay may also include other auxiliary information such as icons (e.g., “smiley faces,” emoticons, changing the hue, saturation, brightness, addition of noise of a region, or using other special effects, coloring or underlining a text and the like) to represent information authored by friends of a user or show other identifiers for the authors of the information such as the author's user identifier in system 100 or to distinguish commercial, sponsored and regular information services. Another use of the graphical overlay auxiliary information is to show the cost associated with accessing commercial information services using either color codes for cost or simply using numerical representations for the costs. A user may then select one or more of the graphical elements overlaid on client 402 display by moving a cursor between the graphical elements using keys on client device 102 or by input through a touch sensitive display or through voice input. The selection of an overlaid graphical element generates a new request message to system server 106 from client 402 identifying the choice of the context. A user's choice of the overlaid graphical element is interpreted by system server 106 to generate information services relevant to the chosen context for presentation to a user on client 402 from a database of information services. A user may also define a custom context by manually selecting one or more of the context constituents on a user interface of client 402 or by demarcating the boundaries of the user-defined context. For example, a user can demarcate regions of a visual imagery as a user-defined context by drawing rectangles around regions using drawing features integrated into the user interface of the client 402. In some embodiments, when a plurality of contexts is generated the system might automatically select a context and present information services associated with the context on client 402. In some other embodiments, when a plurality of contexts associated with a plurality of information services is generated, the system may automatically select an information service associated with a context and present the information service on client 402. Such automatic selection of context, list of information services, or an information service may be determined by criteria such as a context relevance factor, availability of services, nature of the information services (i.e. sponsored information service, commercial information service, etc.), user preferences and the like.

Information services presented to a user may have one or more information “chunks” or entries. Each entry may include information in one or more of the following media types: text, audio, still pictures, video, tactile information or environmental control information. Client 402 user interface may include appropriate controls to play, browse and record information services presented. Information services presented may also include attributes such as the time and location of origin and modification of the information service and the author of the information service. The information service presented may also have embedded hyperlinks, which enable a user to request additional information by selecting the hyperlinks. A user may also elect to view information services sorted or filtered based on criteria such as the author, origin location, origin time and accessibility to the information. If the information service has been modified since its initial creation, metadata on the modification history such as author, location, time may also be presented to a user. A user may filter information services presented based on their modification metadata, as described above. Any request for additional information services or a new filtering or sorting of information services may result in a client request with appropriate parameters and a response from system server 106 with new information services.

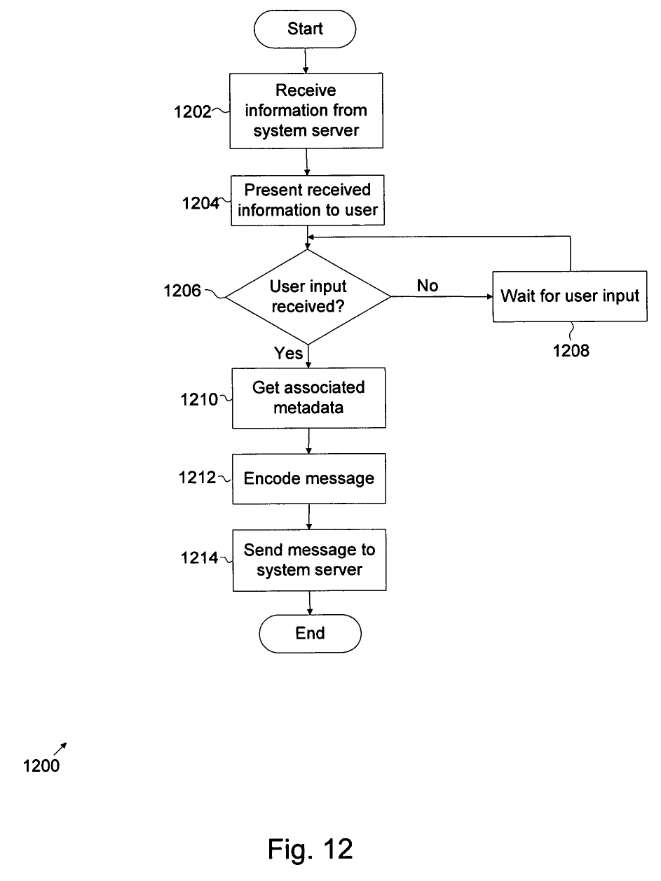

FIG. 12 illustrates an exemplary process for browsing information services from a client, in accordance with an embodiment. Process 1200 presents the operation of system 100 while a user browses and interacts with information services presented on the client 402. In some embodiments, information services are received from system server 106 upon request by the client 402 (1202). The information services are then presented to the user on the client 402 user interface (1204). Then, a determination is made as to whether the user has provided input (e.g., selected a particular information service from those presented) (1206). If the user does not input information, then a delay is invoked while waiting for user input (1208). If user input is entered, then metadata associated with the input is gathered (1210). The metadata is encoded into a message (1212), which is sent to system server 106 in order to place the user's input into effect (1214). Continued interaction of the user with system 100 through client 402 user interface may result in a plurality of the sequence of operations described above for the request and presentation of information services. In other embodiments, process 1200 may be varied and is not limited to the description above. Interacting with the client user interface to select a context or a hyperlink to request associated information services follows a sequence of operation similar to process 1200.

In case the format or the media type used in an information service does not match the presentation capabilities of client device 102, application engine 416 may use synthesis engine 410 and signal processing engine 406 to transform or reorganize the information service into a suitable format. For example, speech content may be converted to a textual format or graphics resized to suit the display capabilities of client device 102. A more advanced form of transformation may be creating a summary of a lengthy text document for presentation on a client device 102 with a restricted (i.e., small) display 216 size. Another example is reformatting a World Wide Web page to accommodate a restricted (i.e., small) display 216 size of a client device 102. Examples of client devices with restricted display 216 size include camera phones, PDAs and the like.

In some embodiments, encoding of the information services may be customized to the available computing and communication resources of client device 102, communication network 104 and system server 106. For example, in some embodiments where the data rate capacity of communication network 104 is very low, visual imagery may be encoded with reduced resolution and greater compression ratio for fast transmission over communication network 104. In other embodiments, where the data rate capacity of communication network 104 is greater, visual imagery may be encoded with greater resolution and lesser compression ratio. The choice of encoding used for the information services may also be dependent on the computational resources available in client device 102 and system server 106. Further, in some embodiments, resource aware signal processing algorithms that adapt to the instantaneous availability of computing and communication resources in the client device 102, communication network 104 and system server 106 may be used.

When a user selects a hyperlink or clicks a physical or soft key on client device 102, a number of parameters of a user interaction are transmitted to system server 106. These include, but are not limited to, key clicked by a user, position of options selected by a user, size of selection of options selected by a user, duration of selection of options selected by a user and the time of selection of options by a user. These inputs are interpreted by system server 106 based on the state of the user's interaction with client 402 and appropriate information services are presented on client device 102. The input parameters communicated from client 402 may also be stored by system 100 to infer additional knowledge from the historical data of such parameters. For example, the difference in time between two consecutive interactions with client 402 may be interpreted as the time a user spent on using the information service that he was using between the two interactions. In another example, the length of use of a given information service by multiple users may be used as a popularity measure for the information service.

Generating contexts from a plurality of context constituents may proceed in a progressive fashion such that the number of contexts and the narrowness of the conceptual meaning implied by the contexts increases as the number of context constituents and the resolution of their definition increases. In some embodiments, contexts may be generated when a user has completed entry of user inputs. In other embodiments, contexts may be generated incrementally as a user is typing, using the input to progressively refine generated contexts. Incremental user and sensor inputs may also be used to progressively narrow a list of information services relevant to a given context. For example, relevant information services may be identified after each character of a textual user input has been entered on the client user interface.

In some embodiments, client 402 may be actively monitoring the environment of a user through available sensors and automatically present, without any explicit user interaction, information services that are relevant to contexts formed by the available context constituents generated from the available sensors. Likewise, client 402 may also automatically present information services when a change occurs in the internal state of client 402 or system server 106. For example, client 402 may automatically present information services authored by a friend upon creation of the information service, where the relationship with the friend is established using the group creation feature described later. A user may also be alerted to the availability of existing or updated information services without any explicit inputs from the user. For example, when a user nears a spatial location that has an information service created by a friend, client 402 may automatically recognize the proximity of a user to the location where the information service is associated by monitoring the location of client device 102, sending an alert (e.g., an audible alarm, beep, tone, flashing light, or other audio or visual indication). In other embodiments, the visual imagery presented on the viewfinder may automatically be annotated with graphical elements denoting the presence of contexts with relevant information services without any inputs from a user. As an extension, an information service relevant to such an automatically generated context may also be presented to a user, without any inputs or interaction from the user.

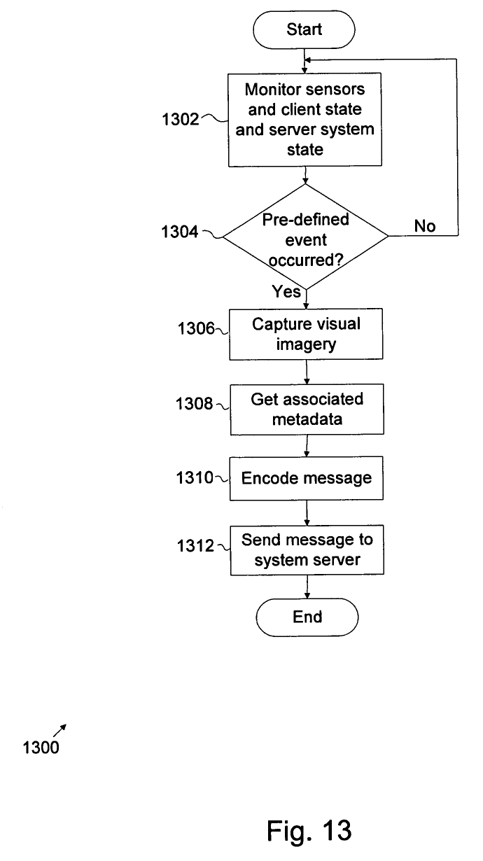

FIG. 13 illustrates an exemplary process for requesting contexts and information services when client 402 is running in autonomous mode and presenting relevant information services without user action, in accordance with an embodiment. Here, process 1200 may be implemented as a sequence of operations for presenting information services automatically. In some embodiments, client device 102 monitors the state of system server 106 and uses sensors to monitor the state of client 402 (1202). As the state of client 402 is monitored, a determination is made as to whether a pre-defined event has occurred (1204). If no pre-defined event has occurred, then monitoring continues. If a pre-defined event has occurred, then visual imagery is captured automatically (1206). Once the visual imagery is captured, associated metadata is gathered from various components of the client 402 and client device 102 (1208). Once gathered, the metadata is encoded in an request message along with the captured visual imagery (1210). The request message is sent to system server 106 (1212). In other embodiments, process 1200 may be varied and is not limited to the description provided above.

Automatic generation of contexts and presentation of relevant information services may also be provided in an iterative mode, where client device 102 updates system server 106 with context constituents obtained form sensors and user inputs. This periodic updating may result in the continual generation of contexts from the available set of context constituents and the identification of information services relevant to the contexts. The identified information services may also be presented automatically to the user. The capture and update of the context constituents from client 402 to system server 106 in an iterative mode may be triggered by pre-defined criteria such as a recurring alarm in clock 214, an autonomous event such as the change in illumination level in the captured visual scenery or under direction from the system server 106 based on criteria determined by system server 106 logic. As an example, in some embodiments, a user points camera 202 integrated into client device 102 at a scene of interest. The client 402 automatically captures visual imagery at periodic intervals and sends it to the system server 106. Contexts are automatically generated from the context constituents generated from the automatically-captured visual imagery. Using these contexts, relevant information services may be automatically identified by the system server 106. Then, the generated contexts may be marked by graphical elements overlaid on the visual imagery displayed in a viewfinder on the client 402 or relevant information services may be automatically presented through the user interface on client 402 without user inputs or operation. The contexts and/or information services presented may also be continually updated with each iteration.

In the operation of system 100 presented above, client 402 communicates immediately with system server 106 upon user interaction on a user interface at client 402 or upon triggering of pre-defined events when client 402 is operating in an automatic information service presentation mode. However, communication between client 402 and system server 106 may also be deferred to a later instant based on criteria such as the cost of communicating, the speed or quality of communication network 104, the availability of system server 106, or other system-identified or user-specified criteria.

Users may also create, edit or delete information services relevant to a context. In some embodiments, creating new information services involves the selection of a context, through a process similar to the process of selecting a context presented for browsing information services. A user captures visual imagery and selects one or more contexts from among the contexts identified and presented on the user interface on client 402. After selecting the contexts, a user switches to the authoring view of a user interface, as illustrated in FIG. 5(c). In an authoring view, a user may input information in one or more of multimedia formats such as textual, visual, audio or tactile information to associate the input information with the selected context. The input tactile information may be stored as tactile information or used to derive textual information as in the case of typing on a keypad or keyboard. The various information input as part of the authoring of the information service may be encoded into a message formatted using a protocol such as that illustrated in FIG. 6 along with associated metadata captured from components of the client 402 and client device 102. The message is then communicated to system server 106, which confirms the creation of a new information service with a response message. System 100 also supports communication of information relevant to contexts involving multiple users (e.g., a group communication service such as voice calls, video conferencing, SMS or group information authoring service such as a Wiki and others). In some embodiments, information services are authored such that the identity of the author is available to users of system 100 and the operators of system 100. In other embodiments, information services may be authored anonymously.

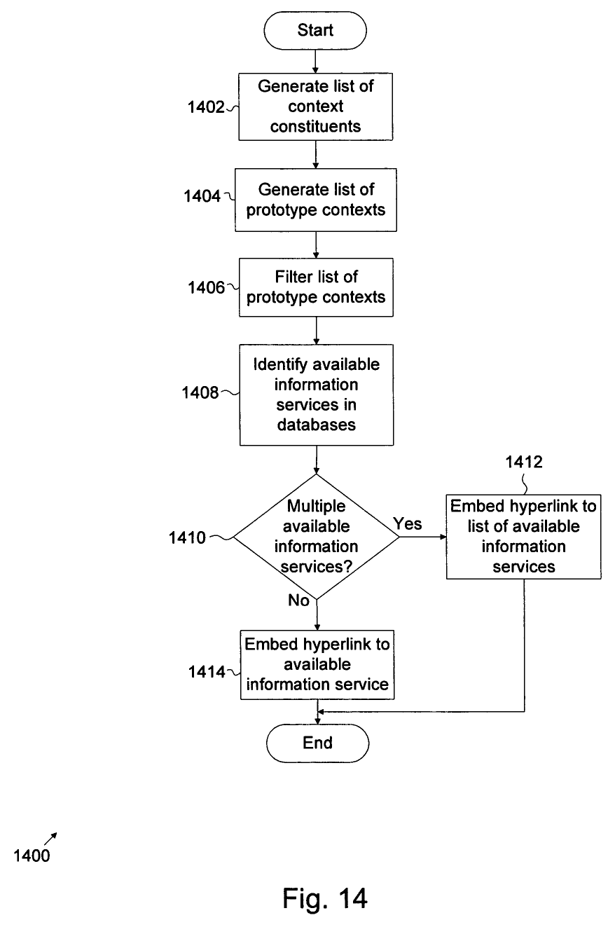

FIG. 14 illustrates an exemplary process for hyperlinking information services to other information services, in accordance with an embodiment. Here, process 1400 may be initiated by application engine 416 generating a list of context constituents (1402). A list of available context constituents may be generated from context constituents used to define the context of a given information service and context constituents extracted from information services. Context constituents may include embedded elements extracted from natural media information in information services, metadata associated with visual imagery, user inputs, and information derived from knowledge bases. Using the list of context constituents, a list of prototype contexts is generated (1404). A list of prototype contexts may be generated using permutation and combination of available context constituents where each prototype context may by comprised of one or more constituents. From a set of n context constituents,

$${\sum }_{r = 1}^{n} n P r$$

prototype contexts may be generated, where P is the mathematical permutation operator and r is the number of context constituents used in a given context.

The list of prototype contexts is filtered to remove entries that are low in relevance value to generate the final list of contexts (1406). Examples of such trivial value prototype contexts include a prototype context comprised of articles like ‘a’ in English language text or a prototype context comprised of the color of a region in an image alone. After generation of the final list of contexts, available information services are identified in various information service knowledge bases (1408).

A determination is made as to whether multiple information services relevant to a generated context are available (1410). If multiple information services are available, a hyperlink to the set of available information services is embedded in the given (i.e., linking) information service (1412). If multiple information services are not available (i.e., a single information service is contextually relevant and available), a hyperlink to the available information service is embedded in the given (i.e., linking) information service (1414). In some embodiments, processes 1408-1414 may be repeated for each generated context. In other embodiments, process 1400 may be varied and is not limited to the description given above. Information associated with information services may also be hyperlinked with other information associated with information services and other information services using a similar process.

User authored information may also contain hyperlinks to other information services available in system 100 or externally. A user may create hyperlinks to newly authored information using the user interface of client 402. System 100 may also be configured to automatically create hyperlinks to newly authored information services based on analysis of newly authored information service as described above.

In some embodiments, contexts with which information services are associated may also be hyperlinked. The structure of the knowledge from knowledge bases 412 used in the composition of the contexts provides a basis for the generation of hyperlinks between contexts. Also, information on a user, client 402, client device 102, and the environment of client 402 in conjunction with the knowledge derived from knowledge bases offer a basis for hyperlinking contexts. For example, a context composed of a spatial location may be hyperlinked to a context composed of the country in which the spatial location is present where the relationship between the spatial location and the geographical location (i.e., the country) is provided by a GIS platform.

Other Features

Authentication, Authorization and Accounting (AAA) features may also be provided in various embodiments. Users may restrict access to information services and information associated with information services based on access privileges specified by them. Users may also be given restricted access to information services and information associated with information services based on their access privileges. Operators of a system and information service providers may also specify access privileges. AAA features may also indicate access privileges for shared information services and information associated with information services. Access privileges may be specified for a user, user group or an information service classification. The authoring view in a client user interface supports commands to specify access rights for user authored information services. The accounting component of the AAA features enables system 100 to monitor use of information services by users, allows users to learn other users' interests, and provides techniques for the evaluation of the popularity of information services by analyzing the aggregated interests of users in individual information services, the tracking of usage of system 100 by users for billing purposes and the like. Authentication and authorization may also provide means for executing financial transactions (e.g., purchasing products and services offered in an information service). As used herein, the term “authenticatee” refers to an entity seeking authentication e.g., a user, user group, operator, provider of information service.

Another feature of system 100 is support for user groups. User groups enable sharing of information services among groups. User groups also enable efficient specification of AAA attributes for information services for a group of users. User groups may be nested in overlapping hierarchies. User groups may be created automatically by system 100 (i.e., through analysis of available information services and their usage) or manually by the operators of system 100. Also, user groups may be created and managed by users through a special ‘Groups’ view on the user interface of client 402 as illustrated by FIG. 5(b). The ‘Groups’ view may also support features for management of groups such as deletion of users, deletion of entire groups and creation of hierarchical groups. The AAA rights of individual users in each group may also be specified. Support for user groups also enables the members of a group to jointly author an information service (e.g., a conference call information service). An example of a simple group is a list of friends of a particular user.

The AAA features may also enable use of Digital Rights Management (DRM) to manage information services and the information associated with information services. While the authentication and authorization parts of AAA enable simple management of users' privileges to access and use information services, DRM provides enhanced security, granularity and flexibility for specifying user privileges for accessing and using information services, the information associated with information services and other features such as user groups and classifications. The authentication and authorization features of AAA provide the basic authentication and authorization required for the advanced features offered by DRM. One or more DRM systems may be implemented to match the capabilities of different system server 106 and client device 102 platforms or environments.

Some embodiments support classification of information services through explicit specification by users or automatic classification by system 100 (i.e., using context constituents and information service content). When classifications are created and made available to a user, the user may select classes of information services from menus on a user interface on client 402. Likewise, a user may also classify information services into new and existing classes. The classification of information services may also have associated AAA properties to restrict access to various classifications. For example, classifications generated by a user may or may not be accessible to other users. For automatic classifications of information services and information associated with information services, system 100 uses usage statistics, user preferences, media types used in information services, context constituents used to generate contexts with which the information services are associated and analysis of the information associated with information services as parameters for creating classifications and for assigning the information services and information associated with information services to classifications.

In some embodiments, the use of AAA features for restricting access to information services and the accounting of the consumption of information services may also enable the monetization of information services through commercial and sponsored information services. Commercial and sponsored information services may be authored and provided by third party information services providers or other users of system 100. An example of a commercial information service is a “visual stock quote service” that presents information relevant to a stock ticker symbol extracted from visual imagery, for a fee. An example of a sponsored information service is an “advertisement information service” that provides advertisements relevant to a context. Commercial and sponsored information service providers may associate information services to a context by specifying the context constituents for the context. The accounting part of the AAA features monitors the use of commercial information services, bills users for the use of the commercial information services, and compensates providers of the commercial information services for providing the commercial information service. Similarly, the accounting part of the AAA features monitors the use of sponsored information services and bills providers of the sponsored information services for providing the sponsored information services.

In some embodiments, users may be billed for use of commercial information services using a pre-paid, subscription, or pay-as-you-go transactional model. In some embodiments, providers of commercial information services may be compensated on an aggregate or transactional basis. In some embodiments, providers of sponsored information services may be billed for providing the sponsored information services on an aggregate or transactional basis. In addition, shares of the revenue generated by a commercial or sponsored service may also be distributed to operators of system 100 and providers of context constituents that were used to access the commercial or sponsored information service.

In some embodiments, the cost of a commercial information service is set at a fixed value determined by the provider of the commercial information service and the operators of system 100. In other embodiments, the cost of a commercial information service is set at a dynamic value determined by the provider of the commercial information service and the operators of system 100. In some embodiments, the dynamic pricing for the information services may be based on the usage statistics of the individual information services, the popularity of the authors of the individual information services and other criteria. In other embodiments, the choice of the commercial information service provided as relevant to a context may be determined by a random pick.

In some embodiments, the cost for providing a sponsored information service is set at a fixed value determined by the provider of the sponsored information service and the operators of system 100. In some embodiments, dynamic price may be determined based on usage statistics such as the frequency of use of the sponsored information services, the time of use of the sponsored information services, the duration of use of the sponsored information services and the location of use of the sponsored information services. In other embodiments, the cost of a sponsored information service is set at a dynamic value determined by the provider of the sponsored information service and the operators of system 100. In some embodiments, when a plurality of providers of the sponsored information services are interested in providing sponsored information services relevant to a specific context, the choice of the sponsored information service provided as relevant to a context or the priority assigned to each of the plurality of sponsored information services is determined through a forward auction process. In other embodiments, the choice of the sponsored information service provided as relevant to a context may be determined by a random pick.

The forward auction process for providing sponsored information services relevant to a context may be configured as a market. When a user requests sponsored information services relevant to a context for which a plurality of providers of sponsored information services are interested in providing sponsored information services, system 100 may identify the highest bidder for providing a sponsored information service relevant to the context. The process of identifying the highest bidder involves a first step of each of the providers of sponsored information services specifying a maximum price they are willing to pay for providing sponsored information services relevant to a context and a minimum auction increment value. As a second step, when a sponsored information service relevant to a context is requested, system 100 automatically increments the price assigned to the sponsored information services in the market for a specific context by the specified increment values until the highest bidder is identified. While incrementing the price for each sponsored information service, if the price crosses the maximum specified by a provider of sponsored information services, the corresponding sponsored information service is dropped from the bidding.

As an example, the textual elements “GoodShoe” and “shoe”, the location San Francisco and the date Aug. 15, 2004 are provided as context constituents for generating contexts for sponsored information services. The maximum price bid for associating a sponsored information service with the context composed of the context constituents “GoodShoe” and the location San Francisco from one provider of sponsored information services may be $0.50. There may also be a second provider who bids a maximum of $1.00 on a context composed of context constituents “shoe” and the location “San Francisco.” If a user were now to capture visual imagery using client 402 with the embedded text “GoodShoe” near San Francisco, then the system may present the sponsored information service from the first bidder to the user on the user interface of client 402. However, if a user were to capture a visual image of the text “shoe” using client 402 near San Francisco, then the system may present the sponsored information service from the second bidder to the user on the user interface of client 402.

In some embodiments, a single information service may also include regular, sponsored and commercial information service features. An example of an information service including both commercial and sponsored information service features is an entertainment information service that includes a trailer and a full-length feature film. In such an information service, the trailer may be a sponsored information service while the full-length feature film may be a commercial information service.

As an extension of the billing model, a fraction of the payment amount paid by providers of commercial and sponsored information services may also be paid to a provider of context constituents with which the commercial or sponsored information service is associated. For example, if the text “GoodShoe” appears on a billboard and is used as a context constituent to obtain sponsored information services from the manufacturers of “GoodShoe” products, a fraction of the cost of providing the sponsored information services charged to providers of the sponsored information services (i.e., the manufacturers of “GoodShoe” products) may be paid to owners of the billboard.

In other embodiments, if a non-sponsored information service provider provides a non-sponsored information service that shares a context with a sponsored information service, the provider of the non-sponsored information service may be paid a fraction of the amount paid by the providers of sponsored information services to operators of the system for providing the sponsored information service. This sharing of the sponsored information service fee provides an incentive for providers of non-sponsored information services to create a multitude of non-sponsored information services for diverse contexts, which in turn encourages greater system adoption and usage.

When a user operates client 402 to access information services relevant to a specific context, the list of information services presented to the user may include commercial, sponsored and regular information services. While the relevance of regular information services is determined based solely on their relevance to contexts, the relevance of commercial and sponsored information services is determined may be their inherent relevance to the contexts, the price associated with the commercial or sponsored information services and other auxiliary criteria (e.g., business relationships, time of purchase of license to associate commercial or sponsored information services to context, etc.).

In some embodiments, the available list of commercial, sponsored and regular information services relevant to a context, the commercial, sponsored and regular information services may be interspersed with each other. In other embodiments, they may be separated out into independent lists. The separation into independent lists may be through spatial layout, temporal layout, through use of different media formats (e.g., text, audio, video), through use of different presentation devices for different information services (e.g., sponsored information services on a mobile phone, non-sponsored information services on a television display) or others. In some embodiments, commercial, sponsored, and regular information services may have different representations. For example, hyperlinks to commercial, sponsored, and regular information services may use different colors, icons, or other graphical marks. In some embodiments, sponsored and commercial information services may be presented with other information services without user input or solicitation. In some embodiments, the sponsored information service may be presented prior to the presentation of other information services relevant to a context.

Providers of commercial and sponsored information services may create or author, manage and associate to a context, commercial and sponsored information services using the information service authoring functionality offered by client 402 in some embodiments. Providers of commercial and sponsored information services may also create or author, manage and associate to a context, commercial and sponsored information services using other tools such as a Web browser or specialized authoring software on a Personal Computer.

In some embodiments, markets for associating commercial and sponsored information services with contexts may be integrated system 100. In other embodiments, markets for associating commercial and sponsored information services with contexts may be independent of system 100 and accessed by system 100 through the external information services interface 414 (e.g., the commercial and sponsored information service providers may access the market through a Web browser for associating information services to contexts and for specifying prices). Further, in some embodiments, the markets for associating commercial and sponsored information services with contexts may be operated by operators of system 100. In other embodiments, the markets for associating commercial and sponsored information services with contexts may be operated by other persons or business entities independent of operators of system 100.

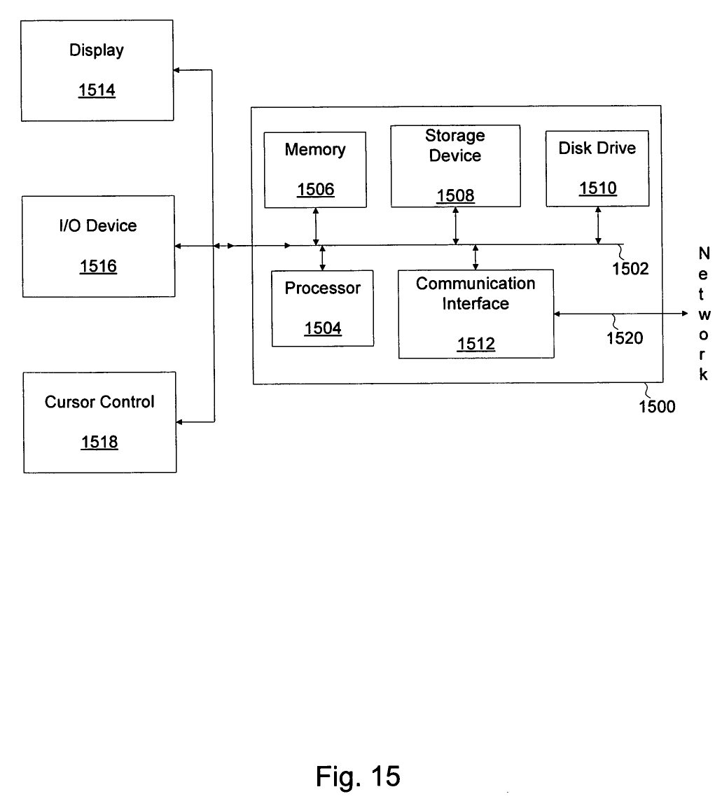

FIG. 15 is a block diagram illustrating an exemplary computer system suitable for providing information services relevant to visual imagery. In some embodiments, computer system 1500 may be used to implement computer programs, applications, methods, or other software to perform the above-described techniques for providing information services relevant to visual imagery such as those described above. Computer system 1500 includes a bus 1502 or other communication mechanism for communicating information, which interconnects subsystems and devices, such as processor 1504, system memory 1506 (e.g., RAM), storage device 1508 (e.g., ROM), disk drive 1510 (e.g., magnetic or optical), communication interface 1512 (e.g., modem or Ethernet card), display 1514 (e.g., CRT or LCD), input device 1516 (e.g., keyboard), and cursor control 1518 (e.g., mouse or trackball).

According to some embodiments, computer system 1500 performs specific operations by processor 1504 executing one or more sequences of one or more instructions stored in system memory 1506. Such instructions may be read into system memory 1506 from another computer readable medium, such as static storage device 1508 or disk drive 1510. In some embodiments, hard-wired circuitry may be used in place of or in combination with software instructions to implement the system.

The term “computer readable medium” refers to any medium that participates in providing instructions to processor 1504 for execution. Such a medium may take many forms, including but not limited to, non-volatile media, volatile media, and transmission media. Non-volatile media includes, for example, optical or magnetic disks, such as disk drive 1510. Volatile media includes dynamic memory, such as system memory 1506. Transmission media includes coaxial cables, copper wire, and fiber optics, including wires that comprise bus 1502. Transmission media may also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read.

In some embodiments, execution of the sequences of instructions to practice the system is performed by a single computer system 1500. According to some embodiments, two or more computer systems 1500 coupled by communication link 1520 (e.g., LAN, PSTN, or wireless network) may perform the sequence of instructions to practice the system in coordination with one another. Computer system 1500 may transmit and receive messages, data, and instructions, including program, i.e., application code, through communication link 1520 and communication interface 1512. Received program code may be executed by processor 1504 as it is received, and/or stored in disk drive 1510, or other non-volatile storage for later execution.

Although the foregoing examples have been described in some detail for purposes of clarity of understanding, the system is not limited to the details provided. There are many alternative ways of implementing the system. The disclosed examples are illustrative and not restrictive.

What is claimed:

1. A method for providing an information service relevant to visual imagery comprising performing an operation on a context constituent.

2. The method recited in claim 1, wherein the operation includes generating a context using the context constituent.

3. The method recited in claim 1, wherein the operation includes identifying the information service, the information service being associated with a context.

4. The method recited in claim 1, wherein the context constituent includes a visual element derived from the visual imagery.

5. The method recited in claim 1, wherein the context constituent includes metadata.

6. The method recited in claim 1, wherein the context constituent includes a user input.

7. The method recited in claim 1, wherein the context constituent includes information from a knowledge base.

8. The method recited in claim 4, wherein the visual element includes a textual element.

9. The method recited in claim 4, wherein the visual element includes a graphical element.

10. The method recited in claim 4, wherein the visual element includes a formatting attribute of a textual element.

11. The method recited in claim 4, wherein the visual element includes layout information.

12. The method recited in claim 4, wherein the visual element includes a characteristic associated with a region of the visual imagery.

13. The method recited in claim 4, wherein the visual element is derived from a still image in the visual imagery.

14. The method recited in claim 4, wherein the visual element is derived from a plurality of still images in the visual imagery.

15. The method recited in claim 4, wherein the visual element is derived from a video frame in the visual imagery.

16. The method recited in claim 4, wherein the visual element is derived from a plurality of video frames in the visual imagery.

17. The method recited in claim 4, wherein the visual element is derived from a stitched version of a plurality of still images in the visual imagery.

18. The method recited in claim 4, wherein the visual element is derived from a stitched version of a plurality of video frames in the visual imagery.

19. The method recited in claim 5, wherein the metadata includes a spatial dimension of the visual imagery.

20. The method recited in claim 5, wherein the metadata includes a temporal dimension of the visual imagery.

21. The method recited in claim 5, wherein the metadata includes a time of capture of the visual imagery.

22. The method recited in claim 5, wherein the metadata includes a time of use of a system.

23. The method recited in claim 5, wherein the metadata includes a user location.

24. The method recited in claim 5, wherein the metadata includes a client device location.

25. The method recited in claim 5, wherein the metadata includes information associated with a spatial orientation of a user.

26. The method recited in claim 5, wherein the metadata includes information associated with a spatial orientation of a client device.

27. The method recited in claim 5, wherein the metadata describes a motion of a user.

28. The method recited in claim 5, wherein the metadata describes a motion of a client device.

29. The method recited in claim 5, wherein the metadata includes a characteristic of a client device.

30. The method recited in claim 5, wherein the metadata includes a characteristic of a client.

31. The method recited in claim 5, wherein the metadata includes a characteristic of a communication network.

32. The method recited in claim 5, wherein the metadata includes audio information associated with the visual imagery.

33. The method recited in claim 5, wherein the metadata includes ambient audio information.

34. The method recited in claim 5, wherein the metadata indicates a user preference.

35. The method recited in claim 6, wherein the user input includes text.

36. The method recited in claim 6, wherein the user input includes audio.

37. The method recited in claim 6, wherein the user input includes a still image.

38. The method recited in claim 6, wherein the user input includes a computer synthesized graphic.

39. The method recited in claim 6, wherein the user input includes video.

40. The method recited in claim 6, wherein the user input includes animation.

41. The method recited in claim 6, wherein the user input includes tactile information.

42. The method recited in claim 7, wherein the knowledge base is a user profile database.

43. The method recited in claim 7, wherein the knowledge base is a client device feature and capability database.

44. The method recited in claim 7, wherein the knowledge base is a usage history database.

45. The method recited in claim 7, wherein the knowledge base is an access privilege database.

46. The method recited in claim 7, wherein the knowledge base is a user group database.

47. The method recited in claim 7, wherein the knowledge base is an information service rating database.

48. The method recited in claim 7, wherein the knowledge base is an author rating database.

49. The method recited in claim 7, wherein the knowledge base is an information service classification database.

50. The method recited in claim 7, wherein the knowledge base is a user preference database.

51. The method recited in claim 7, wherein the knowledge base is an environmental characteristic database.

52. The method recited in claim 7, wherein the knowledge base is a logo database.

53. The method recited in claim 7, wherein the knowledge base is a thesaurus database.

54. The method recited in claim 7, wherein the knowledge base is a language grammar, syntax and semantics database.

55. The method recited in claim 7, wherein the knowledge base is a domain specific ontologies database.

56. The method recited in claim 7, wherein the knowledge base is a geographic information system database.

57. The method recited in claim 2, further comprising using information from a domain specific knowledge base to infer implicit knowledge from the context constituent.

58. The method recited in claim 57, wherein the implicit knowledge is a phone number.

59. The method recited in claim 57, wherein the implicit knowledge is a world wide web uniform resource locator.

60. The method recited in claim 57, wherein the implicit knowledge is an email address.

61. The method recited in claim 57, wherein the implicit knowledge is a postal address.

62. The method recited in claim 1, wherein the information service is determined from information stored in a database.

63. The method recited in claim 1, wherein the information service is determined from information stored in an external database.

64. The method recited in claim 1, wherein the information service is a communication service provided by a system component.

65. The method recited in claim 1, wherein the information service is a communication service provided by an external source.

66. The method recited in claim 1, wherein the information service is an entertainment service provided by a system component.

67. The method recited in claim 1, wherein the information service is an entertainment service provided by an external source.

68. The method recited in claim 1, wherein the information service is an environmental control service provided by a system component.

69. The method recited in claim 1, wherein the information service is an environmental control service provided by an external source.

70. The method recited in claim 1, wherein the information service presents information from a World Wide Web resource.

71. The method recited in claim 1, wherein the information service is a commercial information service paid for by a user.

72. The method recited in claim 1, wherein the information service is a sponsored information service paid for by a provider of the sponsored information service.

73. The method recited in claim 1, wherein the information service is a regular information service that is not paid for by a user and not paid for by a provider of the regular information service.

74. The method recited in claim 1, wherein the information service includes a commercial information service and a regular information service.

75. The method recited in claim 1, wherein the information service includes a sponsored information service and a regular information service.

76. The method recited in claim 1, wherein the information service includes a commercial information service and a sponsored information service.

77. The method recited in claim 1, wherein the information service includes a commercial information service, a sponsored information service and a regular information service.

78. The method recited in claim 1, wherein the information service is configured to deliver information.

79. The method recited in claim 1, wherein the information service is configured to add information.

80. The method recited in claim 1, wherein the information service is configured to delete information.

81. The method recited in claim 1, wherein the information service is configured to modify information.

82. The method recited in claim 1, wherein the information service is configured to classify information.

83. The method recited in claim 1, wherein the information service is configured to store information.

84. The method recited in claim 1, wherein the information service is configured to share information with a user.

85. The method recited in claim 1, wherein the information service is configured to restrict access to information for a user.

86. The method recited in claim 1, wherein the information service is configured to communicate information to a recipient using a communication service.

87. The method recited in claim 1, wherein the information service is configured to establish an inter-association using a hyperlink.

88. The method recited in claim 1, wherein the information service is configured to organize information into a hierarchy of folders.

89. The method recited in claim 1, wherein the information service is configured to deliver the information service.

90. The method recited in claim 1, wherein the information service is configured to add the information service.

91. The method recited in claim 1, wherein the information service is configured to delete the information service.

92. The method recited in claim 1, wherein the information service is configured to modify the information service.

93. The method recited in claim 1, wherein the information service is configured to classify the information service.

94. The method recited in claim 1, wherein the information service is configured to store the information service.

95. The method recited in claim 1, wherein the information service is configured to share the information service among users.

96. The method recited in claim 1, wherein the information service is configured to restrict access to the information service for a user.

97. The method recited in claim 1, wherein the information service is configured to communicate the information service to a recipient using a communication service.

98. The method recited in claim 1, wherein the information service is configured to deliver another information service.

99. The method recited in claim 1, wherein the information service is configured to add another information service.

100. The method recited in claim 1, wherein the information service is configured to delete another information service.

101. The method recited in claim 1, wherein the information service is configured to modify another information service.

102. The method recited in claim 1, wherein the information service is configured to classify another information service.

103. The method recited in claim 1, wherein the information service is configured to store another information service.

104. The method recited in claim 1, wherein the information service is configured to share another information service among users.

105. The method recited in claim 1, wherein the information service is configured to restrict access to another information service for a user.

106. The method recited in claim 1, wherein the information service is configured to communicate another information service to a recipient using a communication service.

107. The method recited in claim 1, wherein the information service is configured to communicate using a communication service.

108. The method recited in claim 1, wherein the information service is configured to establish an inter-association between other information services using a hyperlink.

109. The method recited in claim 1, wherein the information service is configured to control a physical system.

110. The method recited in claim 1, wherein the information service is configured to control an information system.

111. The method recited in claim 1, wherein the information service is configured to execute a financial transaction.

112. The method recited in claim 1, wherein the information service is configured to organize another information service into a hierarchy of folders.

113. The method recited in claim 1, wherein the information service includes information in a media type.

114. The method recited in claim 113, wherein the media type is text.

115. The method recited in claim 113, wherein the media type is audio.

116. The method recited in claim 113, wherein the media type is a still image.

117. The method recited in claim 113, wherein the media type is a computer synthesized graphic.

118. The method recited in claim 113, wherein the media type is video.

119. The method recited in claim 113, wherein the media type is animation.

120. The method recited in claim 113, wherein the media type includes tactile information.

121. The method recited in claim 1, wherein the visual imagery is captured from a visual scene of a physical environment.

122. The method recited in claim 121, wherein the physical environment includes a visual display.

123. The method recited in claim 122, wherein the visual display is a television screen.

124. The method recited in claim 122, wherein the visual display is a computer monitor.

125. The method recited in claim 1, wherein the visual imagery includes a pre-recorded stored visual imagery.

126. The method recited in claim 1, wherein the visual imagery includes a still image.

127. The method recited in claim 1, wherein the visual imagery includes a video.

128. The method recited in claim 1, wherein the visual imagery includes a computer generated graphic.

129. The method recited in claim 1, wherein the visual imagery includes animation.

130. The method recited in claim 1, wherein an information service is configured to transform information into a format configured for presentation on a client.

131. The method recited in claim 1, wherein the information service is configured to present the information service with the visual imagery.

132. The method recited in claim 1, wherein the information service is configured to present the information service independent of the visual imagery.

133. The method recited in claim 1, wherein the operation includes determining a relevance factor, the relevance factor indicating relevance of a context to the visual imagery.

134. The method recited in claim 1, wherein the operation includes determining a relevance factor, the relevance factor being used to establish relevance of the information service to the visual imagery.

135. The method in claim 1, wherein the operation includes ranking a plurality of information services based on their relevance to the visual imagery.

136. A method for generating a context to provide an information service relevant to visual imagery, comprising:
generating a context constituent; and
forming the context by performing an operation, wherein the context includes the context constituent.

137. The method recited in claim 136, wherein the operation includes a permutation of a plurality of context constituents.

138. The method recited in claim 136, wherein the operation includes forming an overlapping hierarchy of contexts.

139. The method recited in claim 136, further comprising computing a factor for the context constituent.

140. The method recited in claim 139, wherein the factor is a quantitative metric of a value of the context constituent.

141. The method recited in claim 140, further comprising using a computational model and an input.

142. The method recited in claim 141, wherein the computational model includes a linear mathematical model.

143. The method recited in claim 141, wherein the computational model includes a non-linear mathematical model.

144. The method recited in claim 141, wherein the computational model includes a rule based model.

145. The method recited in claim 141, wherein the computational model uses a classification technique.

146. The method recited in claim 141, wherein the computational model uses information from a knowledge base.

147. The method recited in claim 136, wherein a factor is computed for the context.

148. The method recited in claim 147, wherein the factor is a relevance factor.

149. The method recited in claim 148, further comprising using a computational model and an input.

150. The method recited in claim 149, wherein the input indicates availability of another information service relevant to the context.

151. The method recited in claim 149, wherein the input indicates relevance of the context to the visual imagery.

152. The method recited in claim 149, wherein the input indicates relevance of the context constituent included in the context to the visual imagery.

153. The method recited in claim 149, wherein the input indicates user interest in an information service classification.

154. The method recited in claim 149, wherein the input is information from a knowledge base.

155. The method recited in claim 149, wherein the computational model includes a linear mathematical model.

156. The method recited in claim 149, wherein the computational model includes a non-linear mathematical model.

157. The method recited in claim 149, wherein the computational model includes a rule based model.

158. A method for providing an information service, comprising:
presenting the information service on a client user interface;
displaying an attribute of the information service; and
acquiring a user input and a sensor input.

159. The method recited in claim 158, wherein the information service is presented on the client user interface with the visual imagery.

160. The method recited in claim 158, wherein an attribute of the information service is adjusted to compensate for motion associated with the visual imagery.

161. The method recited in claim 158, wherein the information service is presented on the client user interface independent of the visual imagery.

162. The method recited in claim 158, wherein the user input is acquired when the information service is selected from a plurality of information services.

163. The method recited in claim 158, wherein the user input is acquired when a control associated with the information service is selected.

164. The method recited in claim 158, wherein the user input is acquired when a hyperlink is selected.

165. The method recited in claim 158, further comprising presenting a control configured to play information associated with the information service on the client user interface.

166. The method recited in claim 158, further comprising presenting a control configured to browse the information service on the client user interface.

167. The method recited in claim 158, further comprising presenting a control configured to browse a plurality of information service options on the client user interface.

168. The method recited in claim 158, further comprising presenting a control configured to author information on the client user interface.

169. The method recited in claim 158, further comprising presenting a control configured to classify the information service.

170. The method recited in claim 158, further comprising presenting a control configured to classify another information service

171. The method recited in claim 158, further comprising presenting a plurality of options when a hyperlink is selected.

172. The method recited in claim 171, wherein the plurality of options includes a plurality of information options.

173. The method recited in claim 171, wherein the plurality of options is a plurality of information service options.

174. A computer program product for providing an information service relevant to visual imagery, the computer program product being embodied in a computer readable medium and comprising computer instructions for performing an operation on a context constituent.

175. A computer program product for generating a context to provide an information service relevant to visual imagery, the computer program product being embodied in a computer readable medium and comprising computer instructions for:
generating a context constituent; and
forming the context by performing an operation, wherein the context includes the context constituent.

176. A computer program product for providing an information service, the computer program product being embodied in a computer readable medium and comprising computer instructions for:
presenting the information service on a client user interface;
displaying an attribute of the information service; and
acquiring a user input and a sensor input.
